(19) United States
(12) Patent Application Publication
(10) Pub. No.: US 2025/0050579 A1
(43) Pub. Date: Feb. 13, 2025

(54) FIVE-AXIS 3D PRINTERS AND OPTIMIZED MODELING AND PRINTING TECHNIQUES

(71) Applicant: 2562701 Ontario Ltd., Toronto (CA)

(72) Inventors: Tomasz Pawel Bartczak, Toronto (CA); Calvin Michael Moes, Mississauga (CA); Junyoung Han, Richmond Hill (CA)

(21) Appl. No.: 18/799,842

(22) Filed: Aug. 9, 2024

Related U.S. Application Data
(60) Provisional application No. 63/518,727, filed on Aug. 10, 2023.

(51) Int. Cl. B29C 64/245; B29C 64/209; B29C 64/241; B29C 64/35; B29C 64/393; B33Y 10/00; B33Y 30/00; B33Y 50/02

(52) U.S. Cl. CPC B29C 64/245; B29C 64/209; B29C 64/241; B29C 64/35; B29C 64/393; B33Y 10/00; B33Y 30/00; B33Y 50/02

(57) ABSTRACT

A five-axis 3D printer can include a tilting-rotating bed, and a print head that can be moved relative to the tilting-rotating bed in three orthogonal directions. In some embodiments, printers with tilting-rotating beds can utilize unique or uniquely adapted components and processes for printing processes and associated processes, such as calibration techniques. In some embodiments, these processes may leverage the unique features and advantages provided by such printers. In some embodiments, these processes may address or compensate for potential issues unique to such printers.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims the benefit of U.S. Provisional Application No. 63/518,727, filed Aug. 10, 2023, the disclosure of which is hereby incorporated by reference in its entirety.

### BACKGROUND

The disclosed technology relates to 3-D printers, and in particular to five-axis 3-D printers and associated methods of operation and analysis.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise.

FIG. 1A is a front, right-side perspective view of a five-axis 3-D printer, shown from above.

FIG. 1B is a back, right-side perspective view of the five-axis 3-D printer of FIG. 1A, shown from above.

FIG. 1C is a bottom, left-side perspective view of the five-axis 3-D printer of FIG. 1A, shown from below.

FIG. 1D is a bottom, right-side perspective view of the five-axis 3-D printer of FIG. 1A, shown from below.

FIG. 1E is a front view of the five-axis 3-D printer of FIG. 1A.

FIG. 1F is a top plan view of the five-axis 3-D printer of FIG. 1A.

FIG. 1G is a right side view of the five-axis 3-D printer of FIG. 1A.

FIG. 1H is a left side view of the five-axis 3-D printer of FIG. 1A.

FIG. 2A is a front view of the five-axis 3-D printer of FIG. 1A, with non-planar section lines A-A and B-B shown.

FIG. 2B is a side cross-sectional view of the five-axis 3-D printer of FIG. 1A, shown along non-planar section line A-A of FIG. 2A.

FIG. 2C is a side cross-sectional view of the five-axis 3-D printer of FIG. 1A, shown along non-planar section line B-B of FIG. 2A.

FIG. 3A is a front, right-side perspective view of a print head such as the print head of FIG. 1A, shown from above.

FIG. 3B is a back, left-side perspective view of the print head of FIG. 3A, shown from above.

FIG. 3C is a back, right-side perspective view of the print head of FIG. 3A, shown from below.

FIG. 3D is a front, left-side perspective view of the print head of FIG. 3A, shown from below.

FIG. 3E is a front side view of the print head of FIG. 3A.

FIG. 3F is a right side view of the print head of FIG. 3A, with section line V-V shown.

FIG. 3G is a rear cross-sectional view of the print head of FIG. 3A, taken along section line V-V.

FIG. 3H is a top plan view of the print head of FIG. 3A.

FIG. 4 is a front, right-side perspective view of a five-axis 3-D printer including two independently actuatable extruder tools sharing a common axis.

FIG. 5A is a front view showing a printer including a worm and worm gear set that can be used to control tilting of a print bed.

FIG. 5B is a detail view of the highlighted section of FIG. 5A, with section line C-C shown.

FIG. 5C is a cross-sectional view of the section of FIG. 5B, taken along the section line C-C.

FIG. 5D is a front perspective view of the printer of FIG. 5A, showing the worm and worm gear set that can be used to control tilting of a print bed.

FIG. 5E is a detail view of the highlighted section of FIG. 5D.

FIG. 5F is a perspective view of a worm and worm gear set such as the set illustrated in FIG. 5A, with partial transparency used to illustrate the relative position of various components.

FIG. 6A is a side view of a rotatable printer bed.

FIG. 6B is a top plan view of the rotatable printer bed of FIG. 6A.

FIG. 6C is a bottom perspective view of the rotatable printer bed of FIG. 6A.

FIG. 6D is a side cross-section view of the rotatable printer bed of FIG. 6A, taken along the section line D-D of FIG. 6E.

FIG. 6E is a perspective view of the rotatable printer bed of FIG. 6A, shown installed in a printer, in which a worm and worm gear can be used to control rotation of the rotatable printer bed, with partial transparency used to illustrate the relative position of various components.

FIG. 7A is a perspective view of a delta-style printer having a tilting-rotating bed, with an in-progress model shown supported by the tilting-rotating bed within the volume enclosed by the printer chassis.

FIG. 7B is a side view of the printer of FIG. 7A.

FIG. 7C is a top plan view of the printer of FIG. 7A.

FIG. 7D is a perspective view of the printer of FIG. 7A, with the tilting-rotating bed moved to tilt the in-progress model partially outside of the volume enclosed by the printer chassis, and the print head moved to access the outwardly extending portion of the in-progress model.

FIG. 7E is a side view of the printer of FIG. 7D.

FIG. 7F is a top plan view of the printer of FIG. 7D.

FIG. 8 is a detailed perspective view of an embodiment of a print bed in which a slip ring is used to transmit electrical power and signals indicative of the temperature of the print bed between the rotating and non-rotating portions of the print bed.

FIG. 9A is a perspective view of a 3D printer having a circular tilting-rotating bed.

FIG. 9B is a perspective view of the printer of FIG. 9A, having a supplemental fixed rectangular bed installed over the circular tilting-rotating bed.

FIG. 9C is a perspective view of the components of the supplemental fixed rectangular bed, including a rectangular platform and support brackets.

FIG. 10A is a perspective view of a preheating system including a plurality of light sources arranged around a print head and directed towards the tip of the print head.

FIG. 10B is a side view of the preheating system of FIG. 10A, with only one of the light sources shown as active.

FIG. 11A is a perspective view of a print head probing a location at the edge of a rotating print bed.

FIG. 11B is a perspective view of the print head of FIG. 11A probing a different location at the edge of the rotating print bed, after rotation of the print bed to a different position.

FIG. 12A is a perspective view of a print head probing a location at the edge of a tilting print bed.

FIG. 12B is a perspective view of the print head of FIG. 12A probing a location near the midpoint of the tilting print bed, after tilting of the print bed to a different position.

FIG. 12C is a perspective view of the print head of FIG. 12A probing a location at another edge of the tilting print bed, after tilting of the print bed to a different position.

FIG. 13 is a perspective view of a printer with a rotating build platform, illustrating the build platform and print head being rotated in opposite directions to increase the relative rate of movement of the print head over the build platform.

FIG. 14A illustrates an embodiment of one method for printing a more finely-stepped thinner layer before printing a course internal region.

FIG. 14B illustrates an embodiment of another method for printing a more finely-stepped thinner layer before printing a course internal region, where the outer layers are printed in a pyramidal arrangement.

FIG. 15 is a flow diagram illustrating certain steps that can be performed in conjunction with a method of segmented modeling and printing.

FIGS. 16A to 16C illustrate various print paths that can be used for a layer surface having a curved form, such as the illustrated spherical form.

### SUMMARY

In one broad aspect, a five-axis 3-D printer is provided, including a tilting-rotatable bed including a build platform, a rotating drive mechanism operably connected to the build platform to command a rotational position of the build platform, and a tilting drive mechanism operably connected to the build platform to command a tilt position of the build platform, and a print head positioned above the build platform, at least one of the build platform and print head being movable to command a position of the print head relative to the build platform along three orthogonal axes, at least one of the build platform and print head including a load cell.

The build platform can be supported by an underlying support bracket tiltable by the tilting drive mechanism, and the rotating drive mechanism can be supported by the underlying support bracket. The rotating drive mechanism can be capable of infinitely rotating the build platform. The build platform can be supplied with electrical power via an electrical slip ring. The build platform can be operably connected to at least one of the rotating drive mechanism or the tilting drive mechanism via a worm gear.

The printer can be configured to perform a calibration process to detect a rotational position of the build platform by detecting contact between the print head and the build platform at a plurality of rotational positions of the build platform. The printer can be configured to perform a calibration process to detect a tilt position of the build platform by detecting contact between the print head and the build platform at a plurality of tilt positions of the build platform. The printer can be configured to perform a compensation process to compensate for an expected deflection of the build platform as a model is constructed on the platform, the compensation process including probing the build platform at one or more locations while measuring a force-deflection curve, and adjusting a toolpath of a printing process based on the measured force-deflection curve to compensate for deflection of the build platform due to the construction of a model on the build platform during the printing process.

The print head can be spatially confined within a conical boundary volume originating at a distal tool tip of the print head. The conical boundary volume can be defined by an included angle at the distal tool tip of at 20 degrees or less. The print head can be further spatially confirmed within a cylindrical boundary volume coaxial with a longitudinal axis of the print head passing through the distal tool tip. The cylindrical boundary volume can have a diameter of 20 mm or less.

The print head can include a cooling duct in thermal communication with at least one of a heatsink of the print head and a tool tip of the print head. The cooling duct can be constrained within a conical boundary volume of the print head. The print head can include at least one light source to pre-heat a deposition area.

The print head can be moveable to command a position of the print head relative to the build platform outside of a working volume overlying the tilting-rotatable bed and enclosed by vertical columns of the printer. The printer can further include a tool tip cleaning station, where the tool tip cleaning station is optionally outside of a build volume of the tilting-rotatable bed.

In another broad aspect, a printing process is provided, the printing process including constructing a model using any of the printers disclosed herein.

The printing process can include pausing a printing process to place at least one prefabricated component on a partially printed structure, and continuing the printing process to secure and/or enclose the prefabricated component.

The printing process can include printing unsupported rods of material. The unsupported rods of material can be printed by moving the tool tip approximately along the axis of the rod segment to be formed. The unsupported rods of material can be printed in a layer which is not normal to at least one of a tool tip axis of the print head or an axis of the unsupported rods of material.

The printing process can include rotating the build platform in a first direction about a rotational axis of the build platform during a portion of the printing process, and moving the print head in a second direction about the rotational axis of the build platform during the same portion of the printing process, the second direction opposite the first direction.

Forming an angled surface in the printing process can include depositing a first plurality of layers having a first thickness adjacent the angled surface, and depositing a second plurality of layers having a second thickness away from the angled surface after depositing the first plurality of layers, the first thickness of the first plurality of layers being smaller than the second thickness of the second plurality of layers.

The printing process can include a segmenting process to segment a model into regions to print using different orientations and/or different layering paradigms. The printing process can include printing interlocking shapes or textures at boundaries between regions printed using different orientations and/or different layering paradigms.

The printing process can include printing nonplanar infill patterns while actuating at least one of the rotating drive mechanism or the tilting drive mechanism. The nonplanar infill patterns can have a curve or spiral form. Printing the nonplanar infill patterns can include printing a first layer of material, and altering a direction of a motion component of the tilting-rotatable bed before printing a second layer of material.

Calculating a toolpath for the printing process can include transforming model geometry and/or print path data computed for a printing process in three dimensions to a planar representation in two dimensions, analyzing the two-dimensional planar representation to obtain an output, and transforming the output to three-dimensional information.

The printing process can include conducting an optimization process to analyze stresses and deflections within an object to optimize at least one of type, density, and orientation of infill within the object. The printing process can include conducting an optimization process to locally orient filament deposition lines to directions of maximum stress.

### DETAILED DESCRIPTION

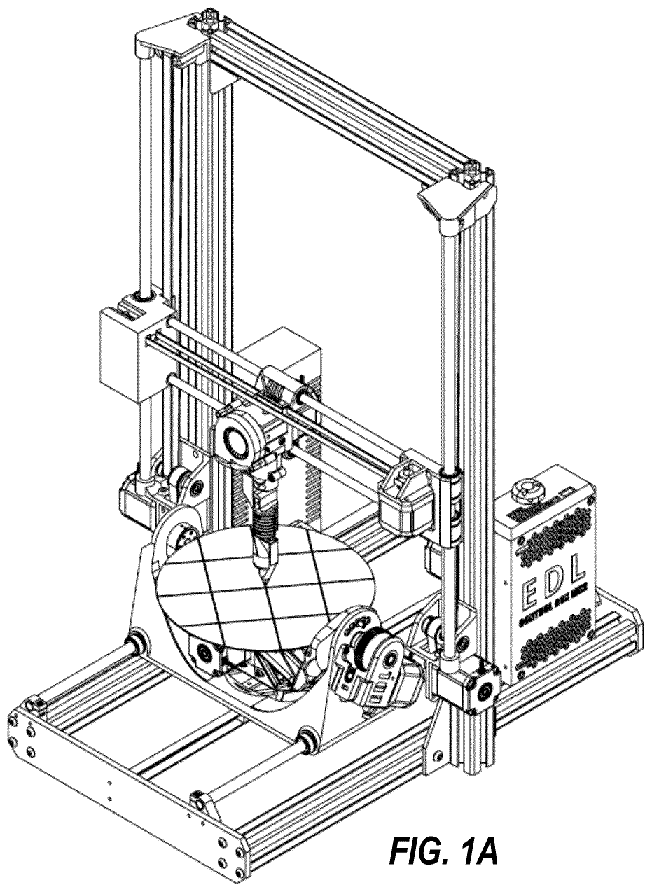

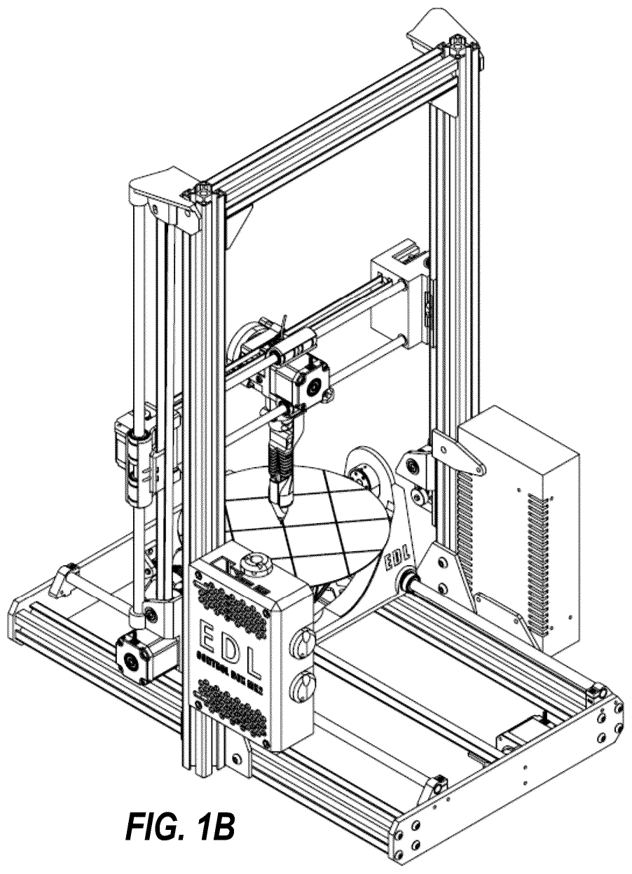

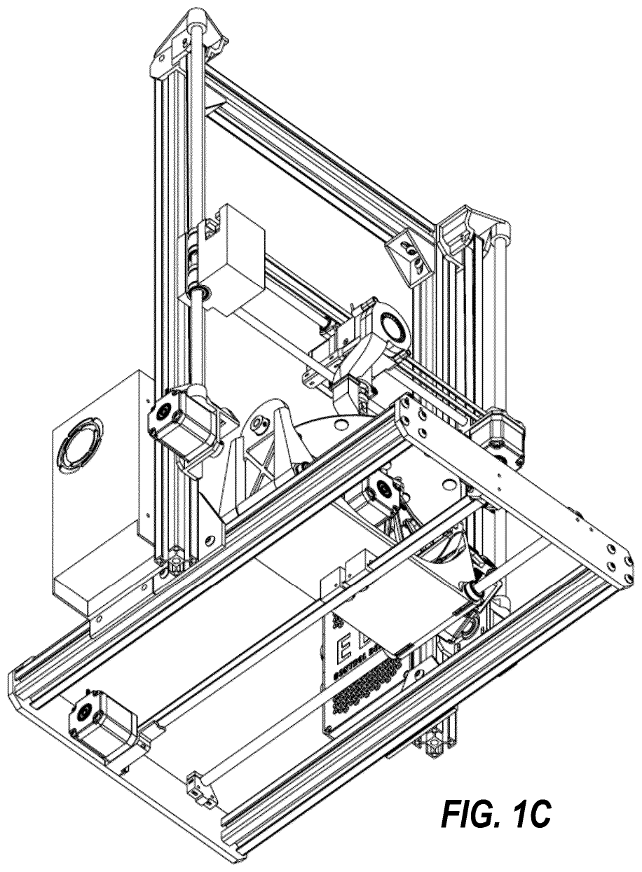

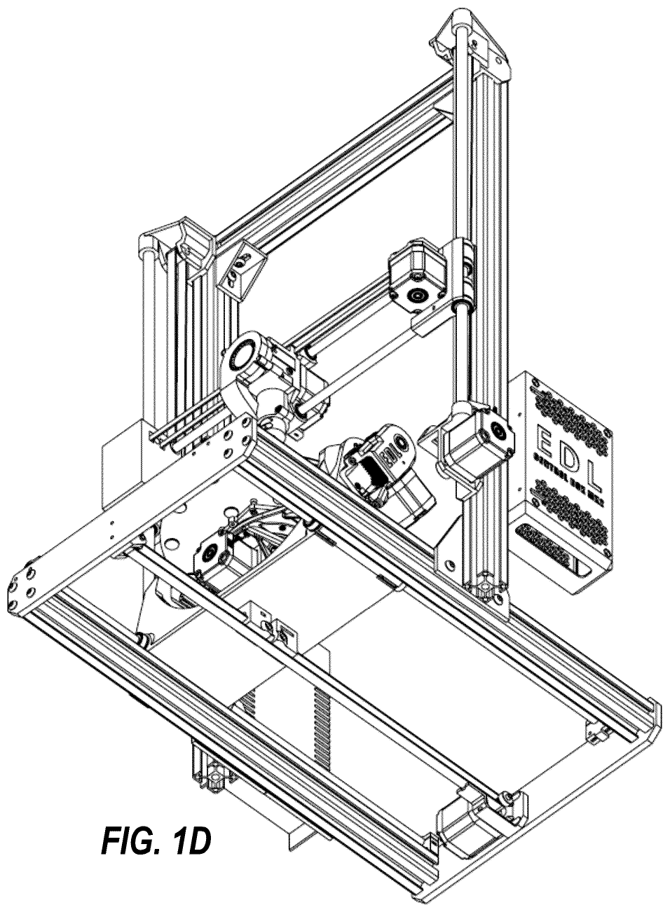

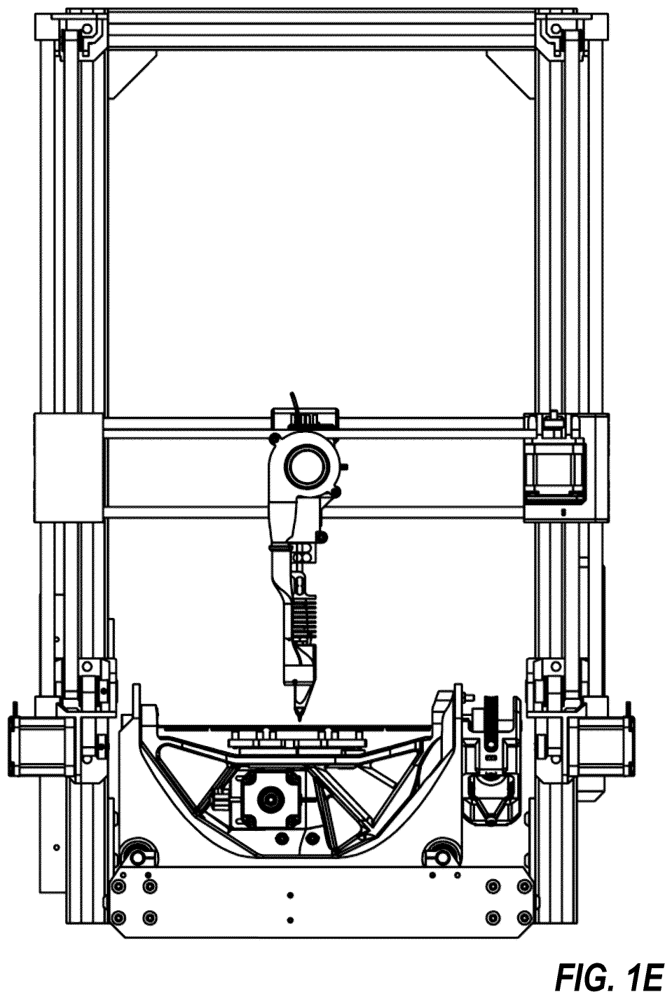

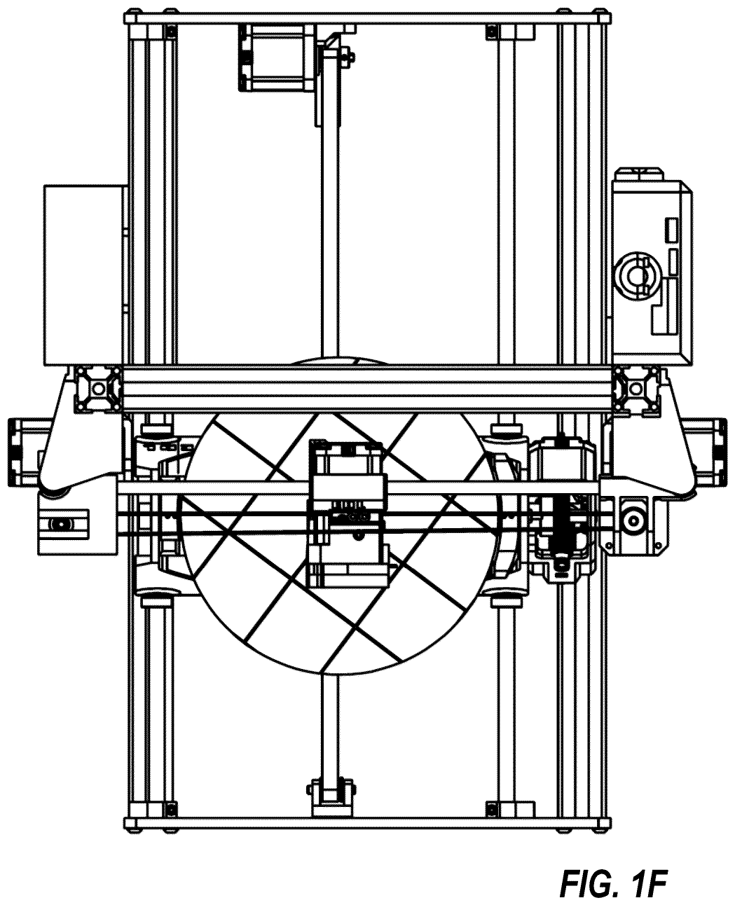

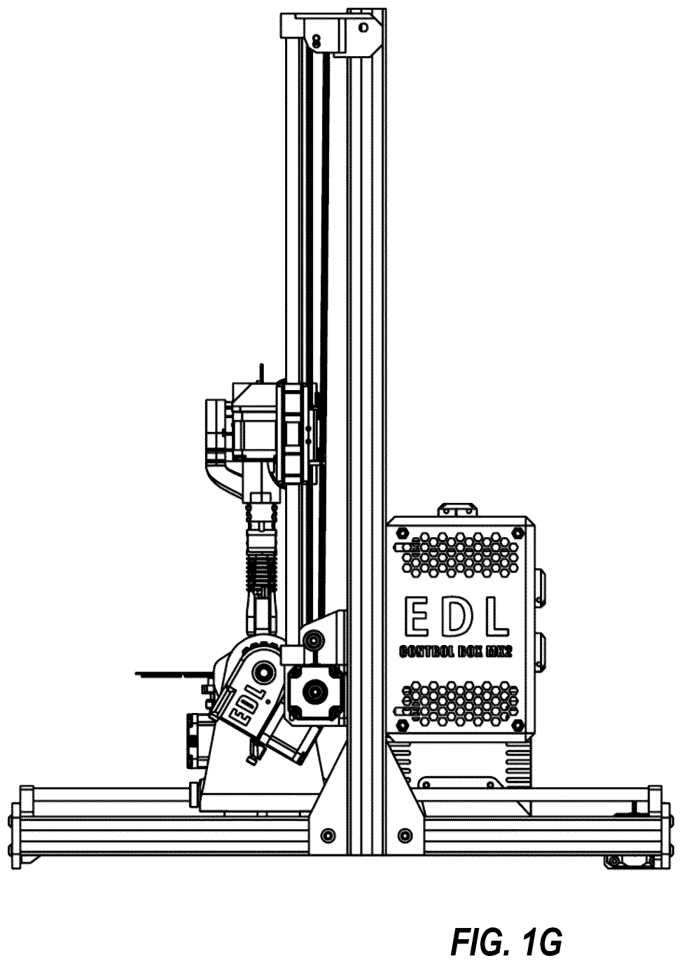

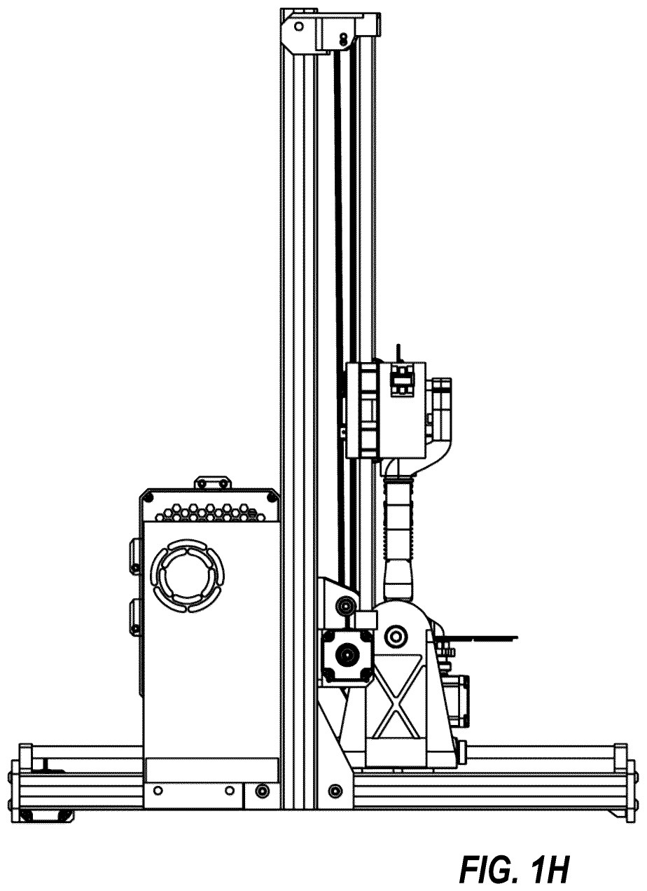

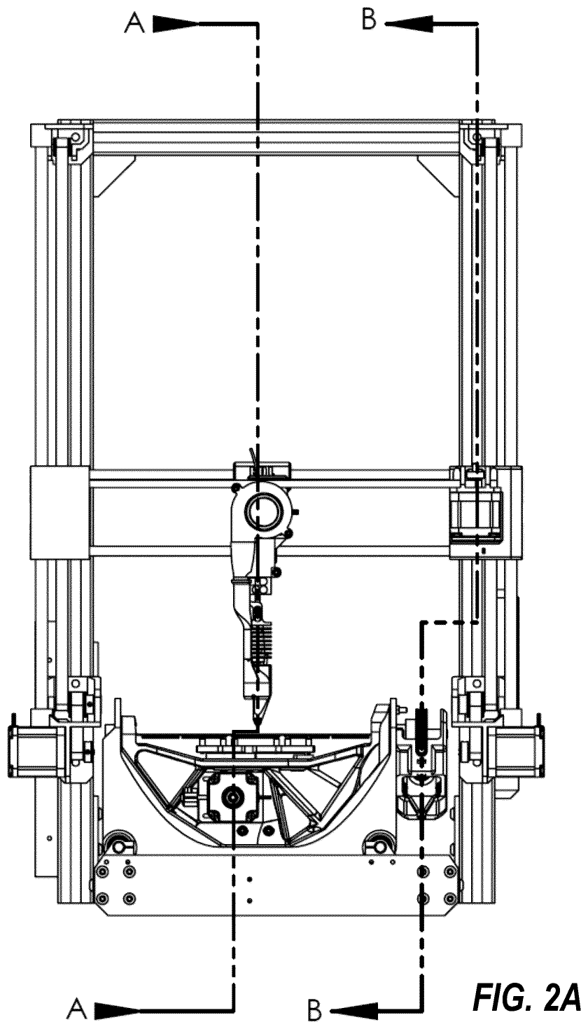

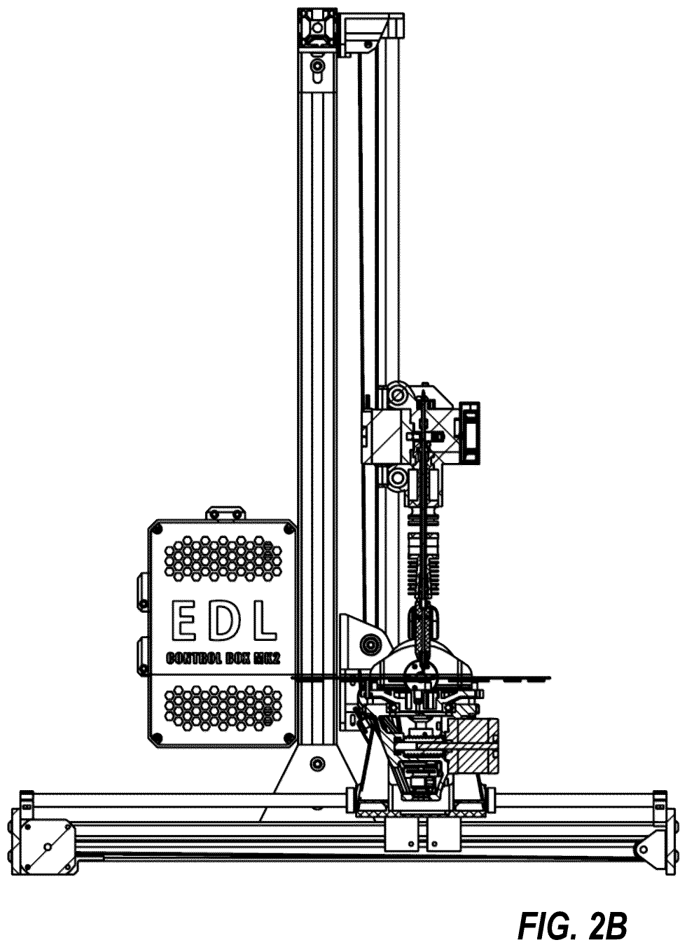

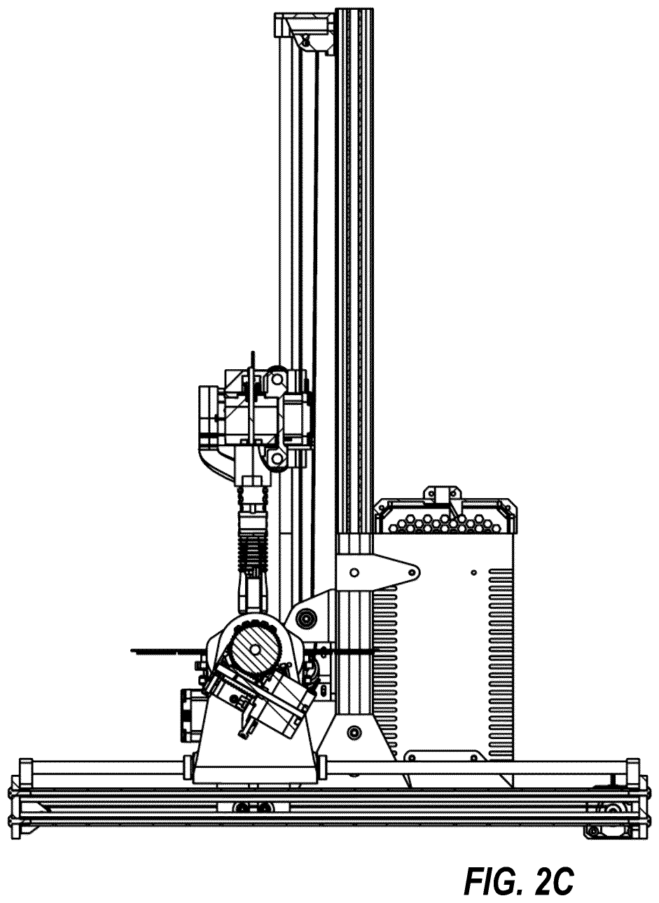

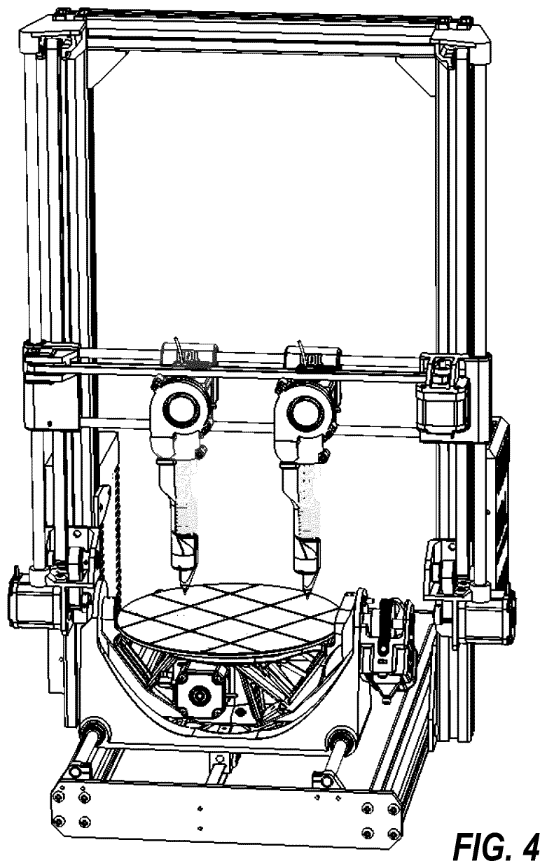

Embodiments of five-axis 3-D printers can include a tilting-rotating bed and at least one extruder tool. In some embodiments, a five-axis 3-D printer can include two or more extruder tools sharing a common axis but independently actuatable. FIGS. 1A-2C show one embodiment of a five-axis 3-D printer, shown with a single extruder tool, also referred to herein as a print head. FIG. 4 shows another embodiment of a five-axis 3-D printer tool having two extruder tools arranged along a common horizontal axis.

FIG. 1A is a front, right-side perspective view of a five-axis 3-D printer, shown from above. FIG. 1B is a back, right-side perspective view of the five-axis 3-D printer of FIG. 1A, shown from above. FIG. 1C is a bottom, left-side perspective view of the five-axis 3-D printer of FIG. 1A, shown from below. FIG. 1D is a bottom, right-side perspective view of the five-axis 3-D printer of FIG. 1A, shown from below. FIG. 1E is a front view of the five-axis 3-D printer of FIG. 1A. FIG. 1F is a top plan view of the five-axis 3-D printer of FIG. 1A. FIG. 1G is a right side view of the five-axis 3-D printer of FIG. 1A. FIG. 1H is a left side view of the five-axis 3-D printer of FIG. 1A.

The five-axis 3-D printer 100 includes a tilting-rotating bed 110 supported by a first set of underlying fixed horizontal rails 160 and configured to be movable along the fixed horizontal rails 160. The tilting-rotating bed 110 includes a build platform 120, which is tiltable through the use of a tilting drive mechanism 130 and rotatable through the use of a rotating drive mechanism 140.

Vertical rails 170 on either side of the extruder tool 300 support an overlying horizontal rail 180 extending perpendicular to the fixed horizontal rails 160. One or more extruder tools 300 can be supported on the overlying horizontal rail 180, so that the extruder tool 300 is suspended over the build platform 120 of the tilting-rotating bed 110.

FIG. 2A is a front view of the five-axis 3-D printer of FIG. 1A, with non-planar section lines A-A and B-B shown. FIG. 2B is a side cross-sectional view of the five-axis 3-D printer of FIG. 1A, shown along non-planar section line A-A of FIG. 2A. FIG. 2C is a side cross-sectional view of the five-axis 3-D printer of FIG. 1A, shown along non-planar section line B-B of FIG. 2A.

As can be seen in FIG. 2A, the non-planar section line A-A passes through the extruder tool 300 and through the rotating drive mechanism 140 underlying the tilting-rotating bed 110. The non-planar section line B-B passes through the tilting drive mechanism 130 connected to the tilting-rotating bed 110 and the vertical drive mechanism 172 which can be used to translate the overlying horizontal rail 180 and the extruder tool 300 supported thereon upward or downward along the vertical rails 170.

As can be seen in FIG. 2B, the rotating drive mechanism 140 may include a motor 142 which is connected via one or more gears, belts, or other suitable mechanisms to a rotational axle 148 of the tilting-rotating bed 110, such that rotation of the motor 142 drives rotation of the tilting-rotating bed 110 through rotation of the rotational axle 148 to command a rotational position of the tilting-rotating bed 110. In an exemplary embodiment, as discussed elsewhere herein, a rotating drive mechanism may include a worm and worm gear set, wherein rotation of a spiral threaded shaft attached to the shaft of motor 142 drives rotation of a toothed gear attached to the rotational axle 148.

As can be seen in FIG. 2C, the tilting drive mechanism 130 may similarly include a motor 132 which is connected via one or more gears, belts, or other mechanism to a tilting axle 138 of the tilting-rotating bed 110, such that rotation of the motor 132 can be used to command a tilting angle of the tilting-rotating bed 110 through rotation of the tilting axle 138. In an exemplary embodiment, as discussed elsewhere herein, a tilting drive mechanism may include a worm and worm gear set, wherein rotation of a spiral threaded shaft attached to the shaft of motor 132 drives rotation of a toothed gear attached to the rotational axle 138.

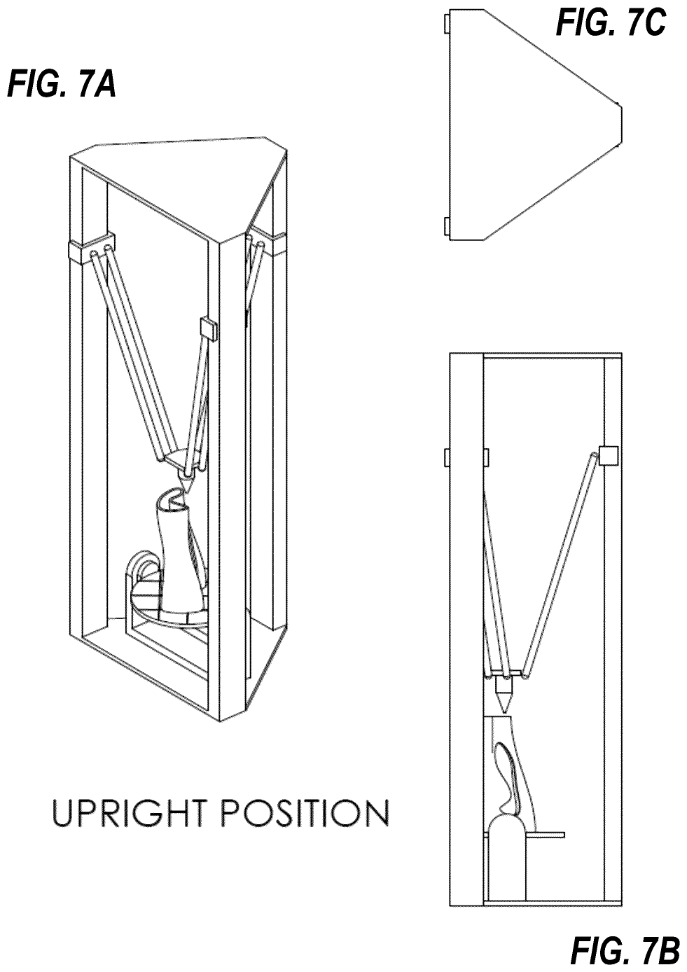

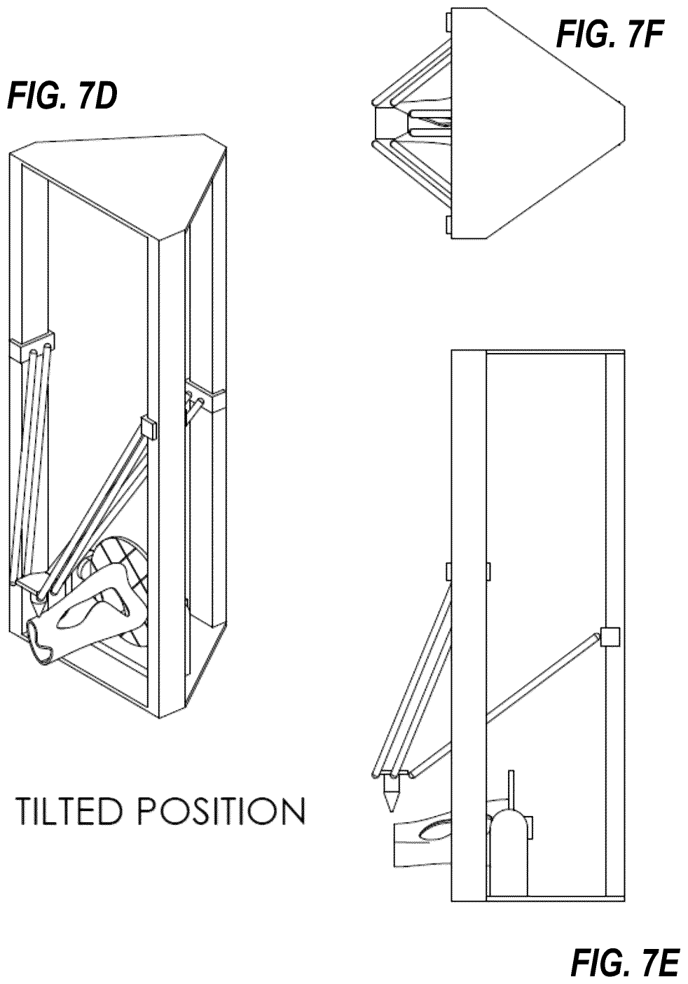

In some embodiments, a delta-style printer with a tilting-rotating bed can be provided. In certain such embodiments, an adjusted mechanical arrangement can be used to allow the print head to reach outside of the volume enclosed by the vertical columns of the printer so that the in-progress model can be accessed when tilted even if regions of the model are tilted outside of a usual working volume enclosed by the printer chassis. FIGS. 7A-7C illustrate various views of a delta-style printer having an in-progress model supported by a tilting-rotating bed.

The delta-style printer 400, like the printer 100 of FIG. 1A, has a print head 404 suspended over a tilting-rotating bed 410. The print head 404 is supported by a plurality of support members 474 connected to independently actuatable driving elements 472 supported by vertical rails 470 surrounding the tilting-rotating bed 410 at the base of the printer. The vertical position of the print head 404 can be controlled by synchronized translation of each of the driving elements 472, while the horizontal position of the print head 404 can be controlled by independent translation of one or more of the driving elements 472 relative to the others.

FIGS. 7D-7F illustrate the same views of the delta-style printer in which the in-progress model has been tilted, using the tilting-rotating bed, so that the in-progress model extends outside of the volume enclosed by the printer chassis. As can be seen in FIGS. 7D-7F, the mechanical arrangement supporting the print head 404 allows the print head 404 to reach out of the volume enclosed by the printer chassis to reach the outwardly extending portion of the in-progress model 402 being constructed on the tilting-rotating bed 410.

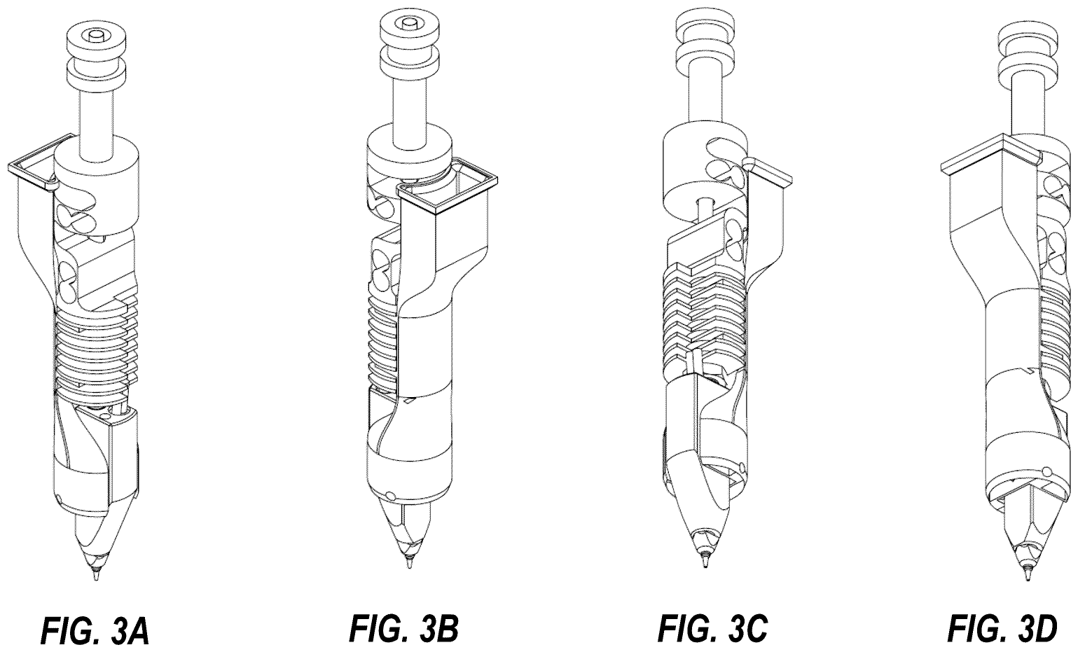

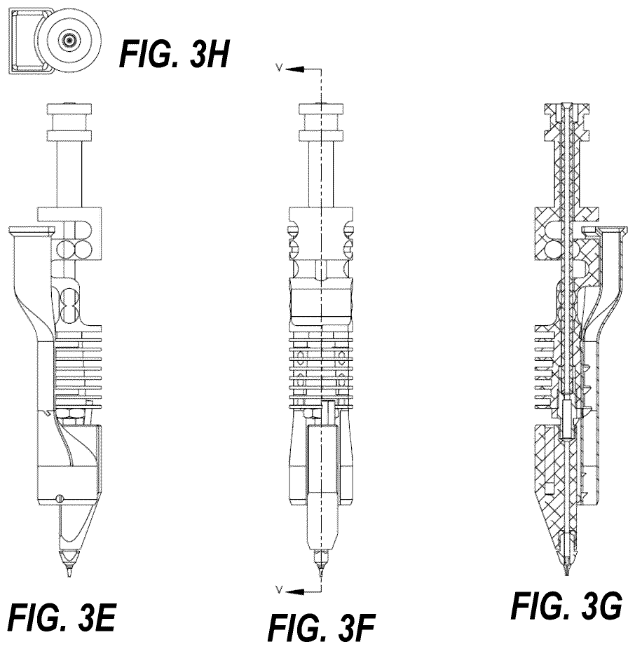

A print head, such as the extruder head illustrated in FIGS. 3A-3H, can include multi-axis sensors, such as a multi-axis load cell. The print head 300 can include sensors or other mechanisms for detecting contact and/or proximity between the print head tool and the build plate. In some embodiments, these features can be used in conjunction with nonplanar printers. In one embodiment, a multi-axis load cell can be used to detect contact between the print head 300 and the build platform for the purposes of alignment, calibration, and crash/fault detection. In other embodiments, other strategies of detecting contact or proximity between the tool and the build plate can be used, including the use of sensors including or utilizing mechanical switches, electrical conduction, induction, or capacitance. In other embodiments, or in addition to the use of sensor mechanisms in the tool type, sensor mechanisms such as load cells or force sensors can be included in or adjacent to the print bed to detect contact with the tool tip 320.

In some embodiments, sensors in the print head may be analog sensors. However, in other embodiments, the sensors may be sensors with digital output, such as a multi-axis load cell with a digital output. A separate local microprocessor can be used with a load cell or other sensor to interpret analog signals, such as analog strain gauge signals, and output a digital signal. In some embodiments, the digital signal can include some or all of the state, direction, and magnitude of the forces acting on the load cell. This can reduce the complexity of hardware and software used to operate the mainboard of the printer by offloading the task of interpreting the strain gauge signals.

In some embodiments, a print head may include a self-cooling duct 310 used to carry air from a distant source to a print head heatsink 330 and a tool tip 320 of the print head for tool and print cooling, respectively. This duct 310 can be contained within the cylindrical profile of the tool to prevent issues of collisions between the tool and the printed parts or the other components of the printer. In some further embodiments, such a duct 310 may be multifunctional, and may be further used as a conduit for cables connected to one or more of heaters, temperature sensors, and contact or proximity sensors. In some embodiments, the duct can carry liquid coolant to cool the heatsink 320 while in parallel conveying air to cool the printed material.

In some embodiments, the print head 300 or other printing tool may be spatially confined to prevent or reduce collisions during a printing process. A printing tool, such as an extended-length printing tool, can be provided in which all components are fitted within a conical and cylindrical boundary originating at the tool tip 320. The angle of the conical boundary can in some embodiments be made as narrow as practical. Similarly, the diameter of the cylindrical portion can also be kept as small as practical. Such a compact design can mitigate issues of access, collisions, and interference between the print head and the printed part and/or build platform.

While an FDM printer operating in planar or horizontal layers generally does not create significant collision issues, various deposition strategies involving nonplanar layers may require the tool tip to be manipulated amongst and around already-printed structures, creating significant potential for collisions. Additionally, spatially confining the print head enables improved access to print objects with the tool in close proximity to and at a shallow angle relative to the bed. In one embodiment, the conical volume surrounding the print head can be defined by an included angle of approximately 20 degrees, and the adjoining cylindrical volume can have a diameter of approximately 20 mm. In other embodiments, the cylindrical section of the confining space can be omitted, and the entire print head is instead confined within an approximately conical volume.

The tilting or rotation of the print bed, such as the print bed of the five-axis 3-D printers of FIGS. 1A-2C or FIG. 4, can be controlled through any suitable mechanism. In some embodiments, it can be desirable for the tilting and rotating functions of the print bed to have high torque, high rigidity, and minimal backlash. While certain of these benefits can be achieved through the use of belt drive mechanisms such as those used for linear translation of components of various embodiments of 3-D printers, alternative driving mechanisms can also be used, and may provide further advantages. In one particular embodiment, the drive mechanism comprises a worm and worm gear set.

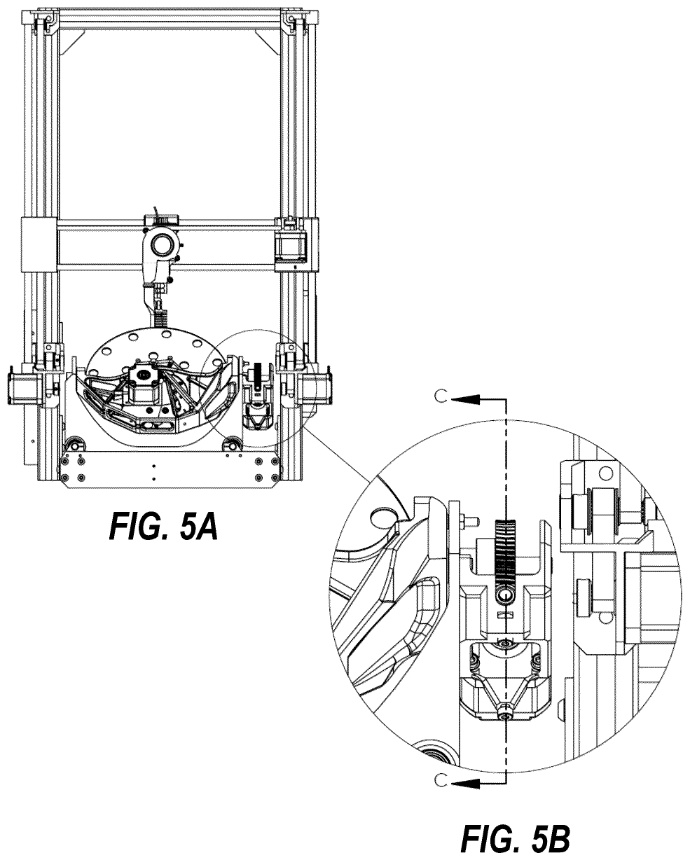

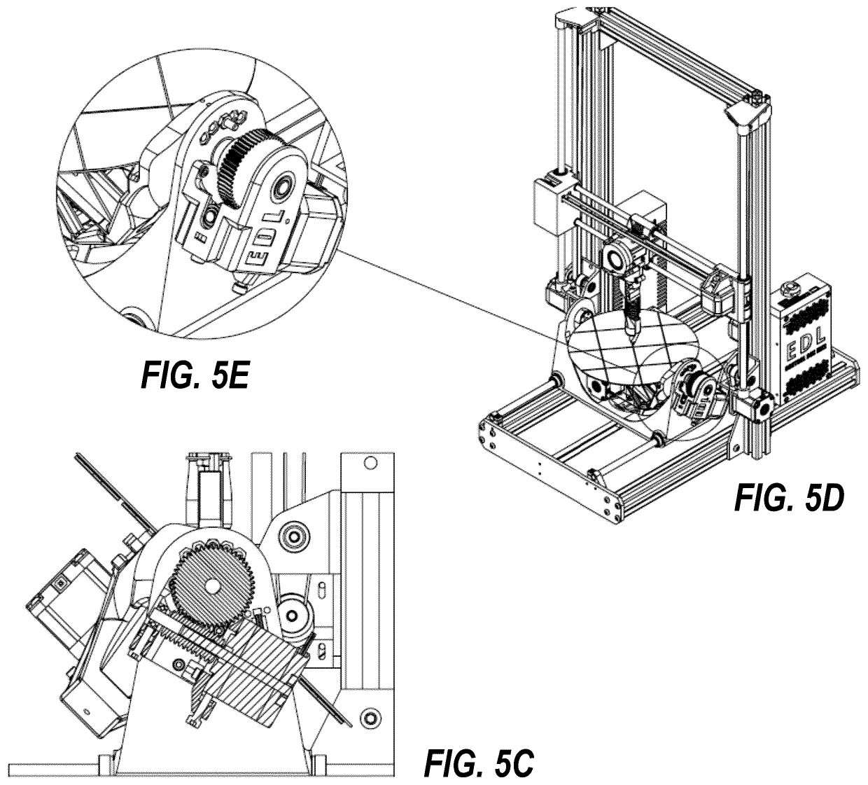

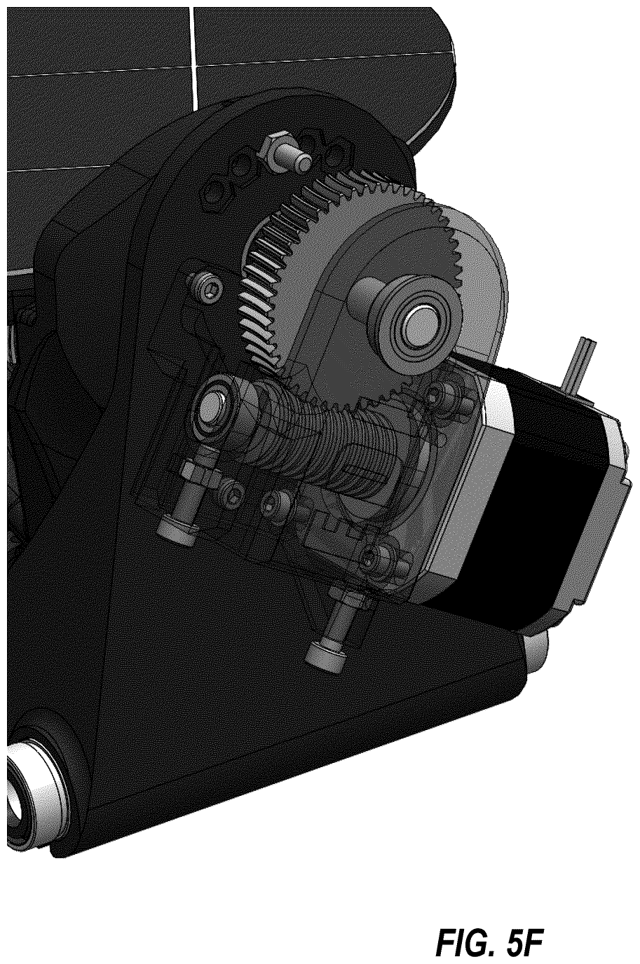

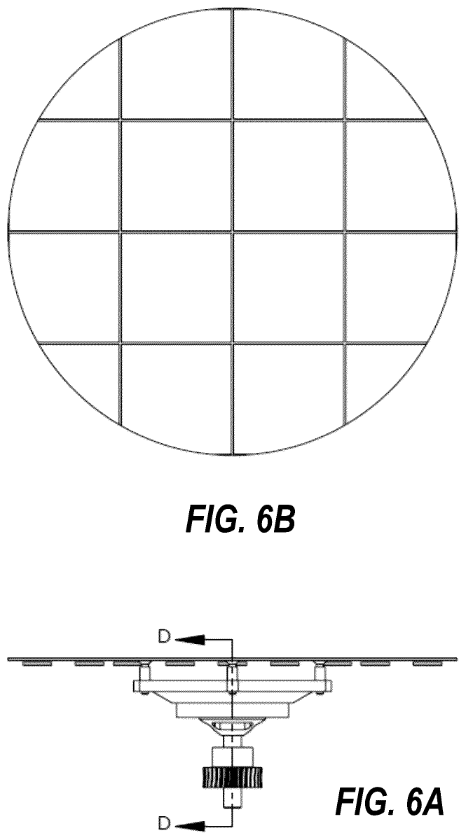

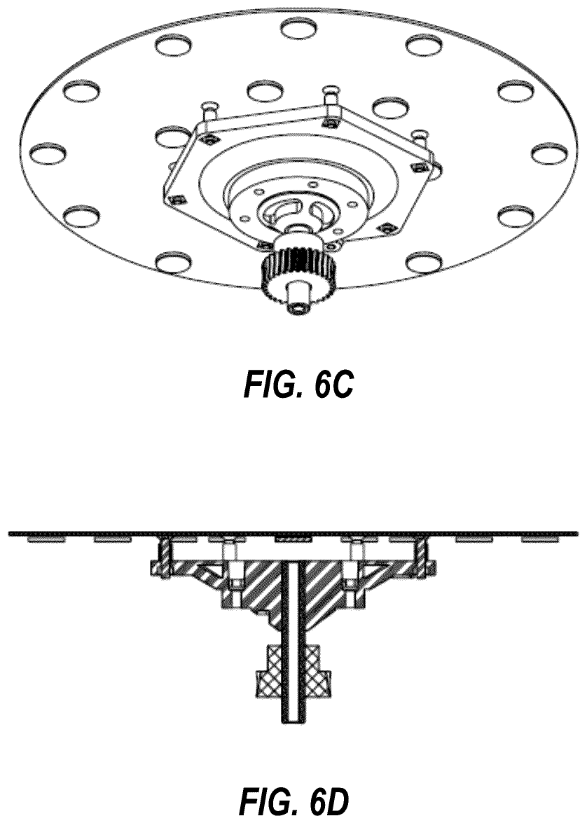

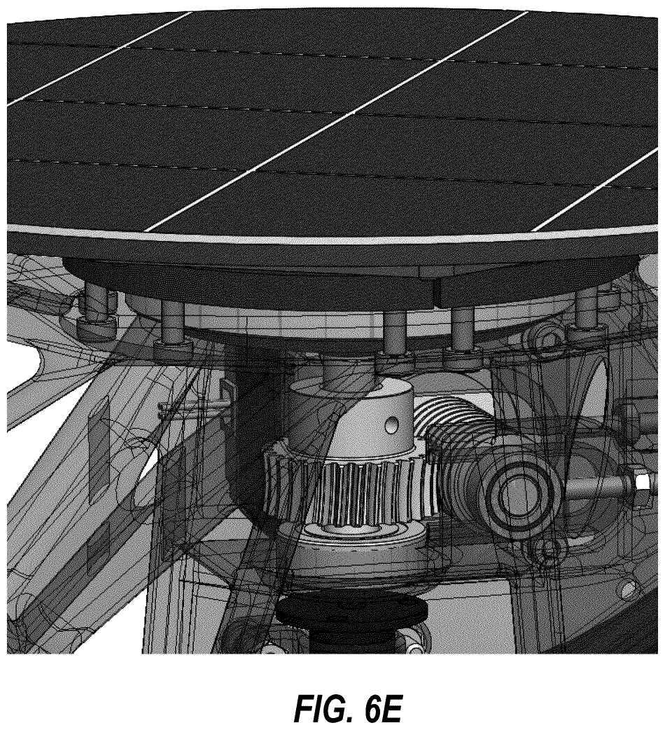

FIGS. 5A to 5F illustrate various views of a worm and worm gear which can be used to control the tilting of a tiltable print bed of a printer. FIGS. 6A to 6E illustrate various views of a rotatable print bet which can be controlled using a worm and worm gear set to control the rotation of a rotatable print bed of a printer. Such a driving mechanism can provide extremely high mechanical advantage, and can prevent the drive mechanism from being back-driven by loads on the bed. However, in other embodiments, at least some or all of the desired advantages can also be provided through the use of strain wave gears, cycloidal gears, planetary gears, or spur gears.

As can be seen in FIGS. 5A to 5F, the motor 132 of the tilting drive mechanism 130 has a worm gear 134 on the shaft of the motor 132 or otherwise operably connected to the motor 132. The worm gear 134 engages a gear 136 connected to a tilting axle 138 supporting the tilting-rotating bed 110. In the illustrated axis, the tilting axle 138 is not a contiguous structure extending from one end of the tilting-rotating bed 110 to the other, but is one shaft of a coaxial pair of shafts forming a split axle on opposite sides of the tilting-rotating bed 110. The tilting-rotating bed 110 is not directly supported by the tilting axle 138, but is instead supported from underneath by an underlying support bracket 102, which in turn is supported by the split axle including the tilting axle 138. Such an arrangement allows the tilting-rotating bed 110 to be rotated around an axis perpendicular to the axis of the tilting axle 138.

As can be seen in FIGS. 6A to 6E, the rotating drive mechanism 140 is supported by the underlying support bracket 102, such that the rotating drive mechanism 140 tilts along with the tilting-rotating bed 110. The motor 142 of the rotating drive mechanism 140 has a worm gear 144 on the shaft of the motor 142 or otherwise operably connected to the motor 142. The worm gear 144 engages a gear 146 connected to a tilting axle 148 supporting the tilting-rotating bed 110.

In some embodiments, a rotating print bed can be configured to be continuously rotatable, without limit. Such continual rotation can reduce or eliminate interruptions in a print project while the position of the print bed is reset. However, such limitless rotation can render infeasible conventional methods of providing heating to a platform, such as the use of a direct wired connection to a heating element on or embedded within the print bed.

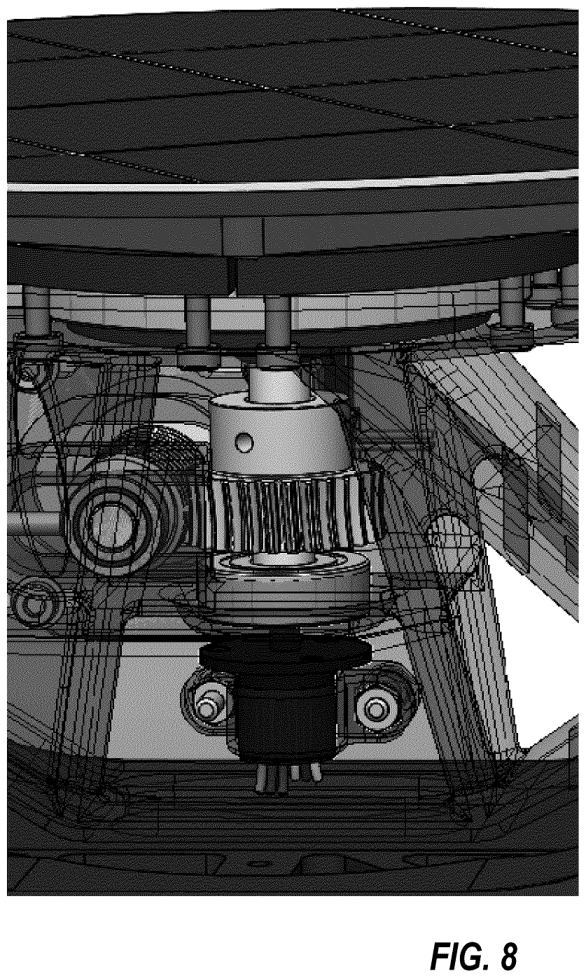

FIG. 8 is a detailed perspective view of an embodiment of a print bed in which a slip ring is used to transmit electrical power and signals indicative of the temperature of the print bed between the rotating and non-rotating portions of the print bed. Such an arrangement allows the use of resistive heating of the print bed while avoiding the use of direct wired connections which would place a constraint on the rotatability of the print bed. In some particular embodiments, the slip ring may be a cylindrical slip ring, and in other particular embodiments, the slip ring may be an annular slip ring. The slip ring may be positioned in various ways beneath or surrounding the rotating portion of the bed.

Other methods of communicating electrical or other types of heating energy to the print bed may be used. In one alternative embodiment, sections of the bed assembly can be constructed using electrically-conductive material, and brush- or leaf-style sliding contacts can be used to transmit electrical power to facilitate resistive heating of the print bed. In another alternative embodiment, heat is applied to the bed via electromagnetic radiation at optical or infrared wavelengths from one or multiple sources on the non-rotating portion of the bed assembly. In such an embodiment, the underside of the bed can be constructed from or coated by a material that is highly absorbent of electromagnetic radiation of the wavelength(s) utilized. In another alternative embodiment, heat can be generated in a non-rotating portion of the print bed and transferred to the rotating portion of the heat bed. In some such embodiments, the build surface can be heated through convective heat transfer by passing heated air across the underside of the rotating portion of the bed, said air to be heated electrically by a device on the non-rotating portion of the bed. This may be optionally enhanced by the addition of fins or other convection-assisting structures to the underside of the rotating portion. This may also be optionally enhanced by recirculating the heated air through the heater to reduce energy consumption.

In some embodiments, a printer with a tilting and/or rotating bed will generally be able to access areas beyond the edges of the bed when the bed is positioned normal to the direction of the print head. This makes it possible to print larger objects on the same printer when not using the tilt and/or rotation functions of the print bed. To utilize this property, a non-rotating print bed can be affixed onto or otherwise secured relative to the existing tilting-rotating bed structure such that the non-rotating bed extends in one or more sections beyond the planar boundaries of the tilting-rotating bed. In one particular embodiment, a rectangular non-rotating bed can be affixed primarily to the non-tilting portion of the underlying assembly. In other embodiments, however, the non-rotating bed can be affixed to the tilting and/or rotating portions of the underlying assembly. In some embodiments, the non-rotating bed attachment includes one or multiple resistive heating elements and temperature sensors, and the printer includes temporary electrical hookups for these features, allowing them to be powered and operated by the printer.

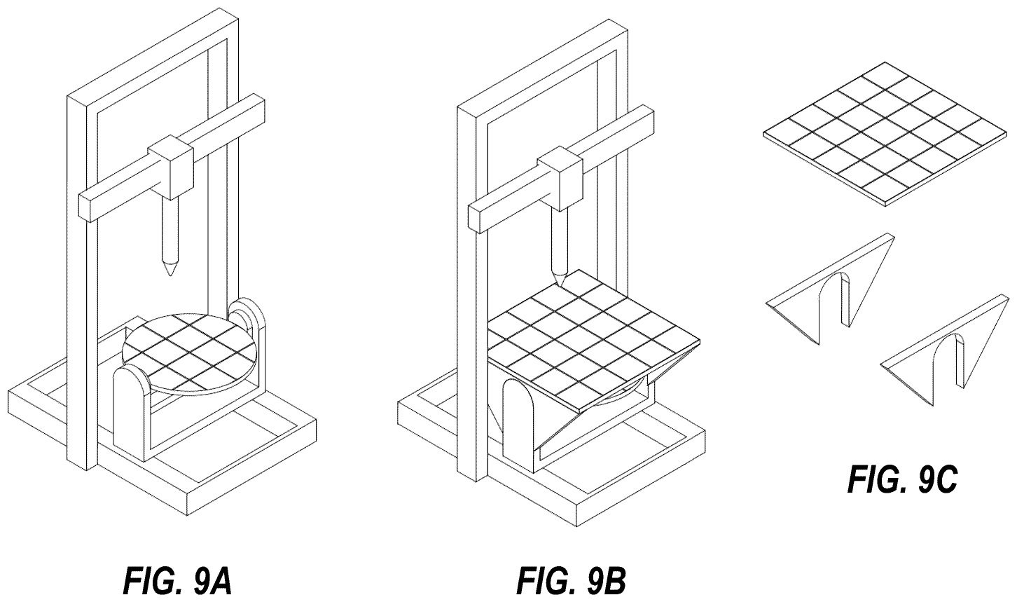

FIG. 9A is a perspective view of a 3D printer 500 having a circular tilting-rotating bed 510. FIG. 9B is a perspective view of the printer of FIG. 9A, having an embodiment of a supplemental fixed rectangular bed 590 installed over the circular tilting-rotating bed. The boundaries of the supplemental fixed rectangular bed 590 extend beyond at least some of the boundaries of the circular tilting-rotating bed 510. FIG. 9C is a perspective view of the components of the supplemental fixed rectangular bed 590, including a rectangular platform 592 and support brackets 594. In some embodiments, the supplemental fixed rectangular bed 590 may be supported at locations which are tiltable via a tilting drive mechanism of the circular tilting-rotating bed 510, such that the supplemental fixed rectangular bed 590 is tiltable, but non-rotatable. In other embodiments, the supplemental fixed rectangular bed 590 may be supported at locations which are not tiltable via a tilting drive mechanism of the circular tilting-rotating bed 510, such that the supplemental fixed rectangular bed 590 is both non-tiltable and non-rotatable

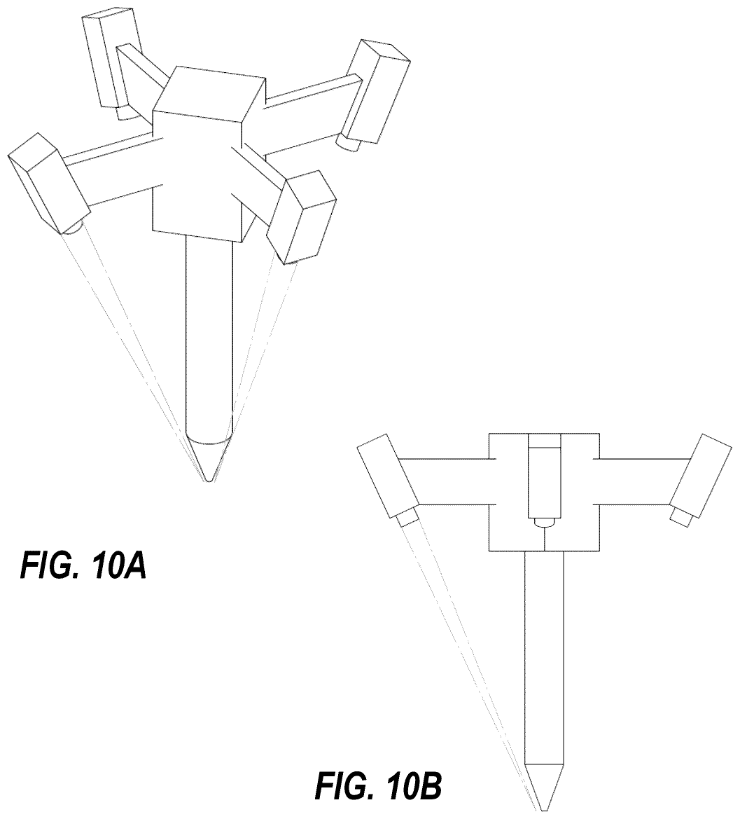

In various embodiments, a five-axis 3D printer can also include or be used in conjunction with one or more peripheral features. For example, in one embodiment, the printer may include or be used with features that pre-heat the deposition area, such as through the use of lasers or focused light. The printer may include a system of one or more visible or IR light sources that selectively heat previously-printed material in the vicinity of the tool tip, just prior to the deposition of additional material, in order to improve adhesion and reduce porosity. In some particular embodiments, this localized pre-heating system uses 3-6 light sources arranged at roughly equal intervals around the print tool and configured to be activated at various power levels based on the instantaneous direction of travel of the tool tip. This can enable the previously-printed material to be selectively heated just ahead of the motion of the tool tip. FIGS. 10A and 10B are perspective views of an embodiment of a pre-heating system, shown with 4 separate light sources 610 arranged around the print head 600 and directed toward the tip 620 of the print head 600. In FIG. 10A, all of the light sources are active, while in FIG. 10B, only one of the light sources 610 is active. Selective actuation of a subset of the overall number of light sources 610 can allow variations in the levels and/or locations of the preheating.

In such an embodiment, and in other embodiments, the power levels of the sources 610 may be controlled in any suitable manner, such as in a steady-state manner or by pulse width modulation. In another embodiment, one or several light sources 610 are mechanically or optically steered to the region of previously-printed material just ahead of the motion of the print head. In some embodiments, the light sources 610 may have user- or machine-adjustable focus. In some embodiments, light is conveyed from the source or sources to the vicinity of the tool tip through optical fibers.

In another embodiment, a printer can include a tool tip cleaning station, which can be located separately from the tilting or rotating components of a tilting-rotating bed. Periodic cleaning of the tool tip during user can be beneficial to certain printing processes. Such cleaning can be accomplished for a tilting-rotating build platform by positioning a piece of rubber, foam, brush, or similar material at a location which can be reached by the tool, such as on a non-tilting section of the printer. The machine can periodically move the nozzle to contact the cleaning station, which can be located within the range of motion of the machine but not within the nominal build volume of the tilting-rotating bed. This method of tool tip cleaning is can be particularly advantageous for a printer with a tilting-rotating bed because a cleaning station on the tilting or rotating subassemblies can introduce undesirable mechanical or kinematic constraints. In a particular embodiment, the cleaning station can be located at a position along the direction of the tilt axis that is fully clear of the tilting of the bed, and somewhat below the height of the bed when level.

In some embodiments, a fused deposition modeling printer may include features which enable monitoring of consumed filament length. In one embodiment, a method of tracking filament consumption, and/or estimating remaining filament, includes the use of filament rolls with unique identifiers, such as RFID tags or QR codes. The printer can record how much filament length has been consumed. In some particular embodiments, this recordation may include tracking the advances and retractions of an extruder mechanism. In some particular embodiments, an independent sensor may be used. The consumed amount may be subtracted from a known length of filament on each spool to provide an estimate of the amount of filament remaining. In some embodiments, this information is conveyed to the slicer software to inform the software or user of the remaining quantity of filament.

In some embodiments, printers with tilting-rotating beds can utilize unique or uniquely adapted processes for printing processes and associated processes, such as calibration techniques. In some embodiments, these processes may leverage the unique features and advantages provided by such printers. In some embodiments, these processes may address or compensate for potential issues unique to such printers.

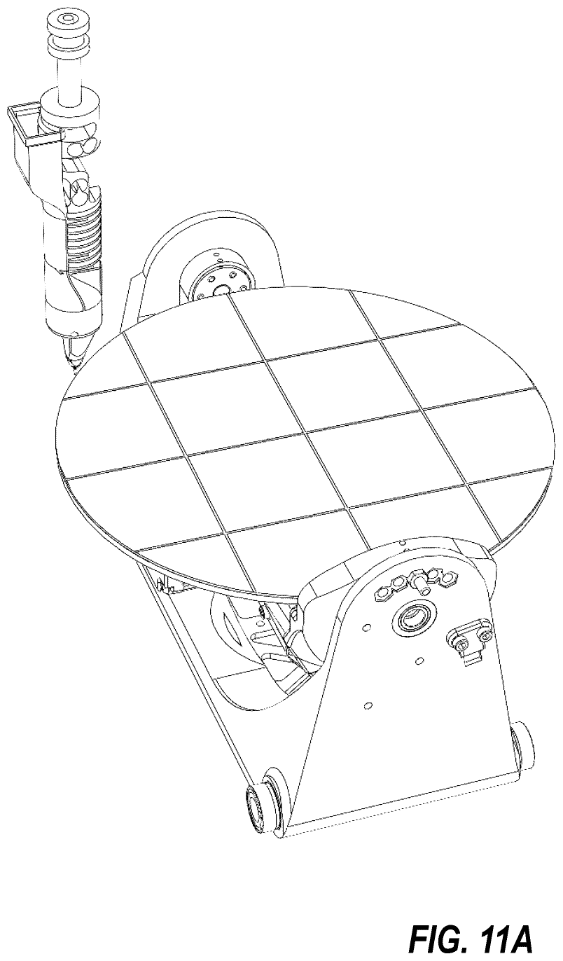

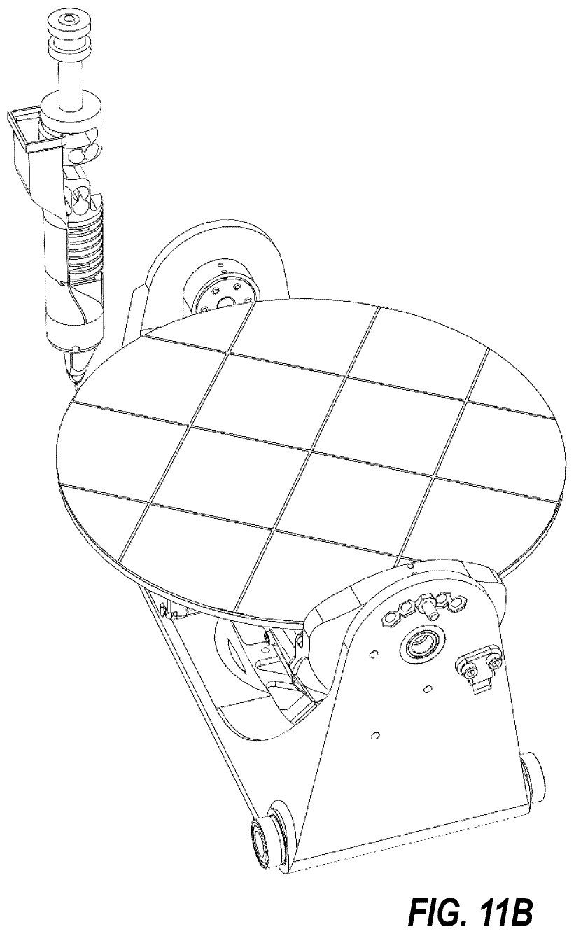

In some embodiments, a method can be used for calibration of the rotation axis of a printer with a rotatable print bed. In certain embodiments, this method can include probing an edge of the build platform at multiple positions. A platform edge 122 can first be probed one or more times at one location, as shown in FIG. 11A. The build platform 120 can be rotated, and additional probing one or more times at another location may be performed, as shown in FIG. 11B. The rotating and probing may be repeating as desired for further improvements to accuracy. In a particular embodiment, this method is applied to a circular build platform, but the method can also be applied to build platforms of arbitrary shapes. In some embodiments, this function can be additionally used to re-calibrate the position of the printer to resume an interrupted print job (e.g. after a power failure or if the print head has collided with another part of the printer or with the in-progress printed object). This method is more generally applicable to calibrating the position of the print head relative to a previously-printed object to conduct additional printing activities on or surrounding the same object.

In other embodiments, a similar technique may be used to locate a tilt angle of a tiltable print bed by probing the build platform at multiple positions and orientations. The technique may be used to accurately locate the tilting axis of the build platform by probing a line of positions along the platform at two or more tilt angles and using geometric relationships to calculate the axis position. This can optionally be repeated at multiple sites along the length of the tilt axis to determine its angular alignment relative to the other machine axes.

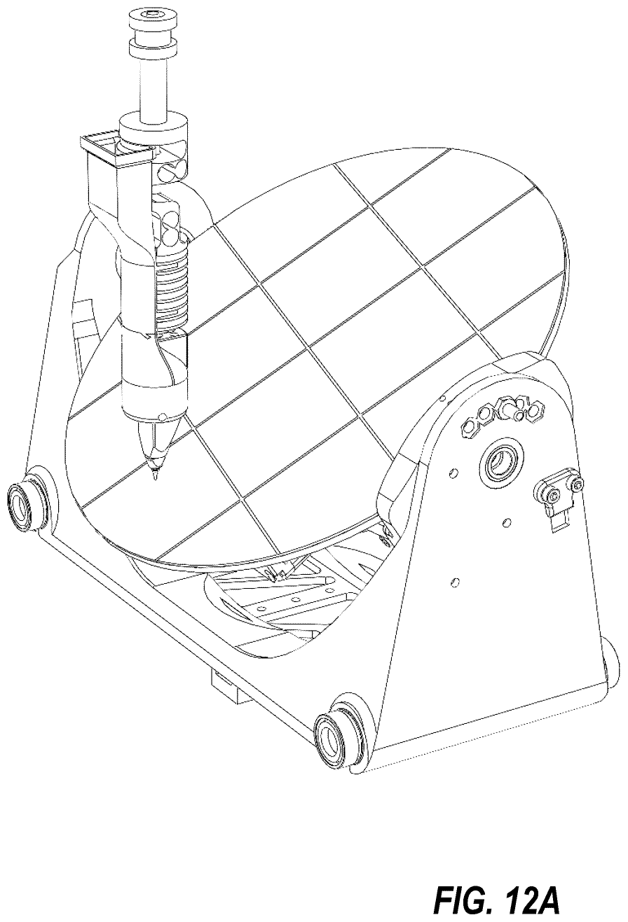

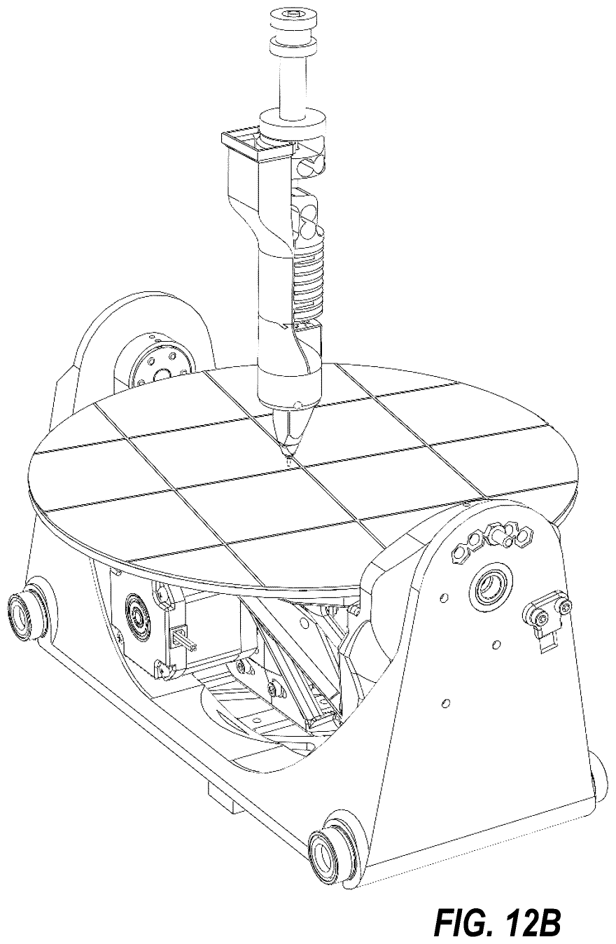

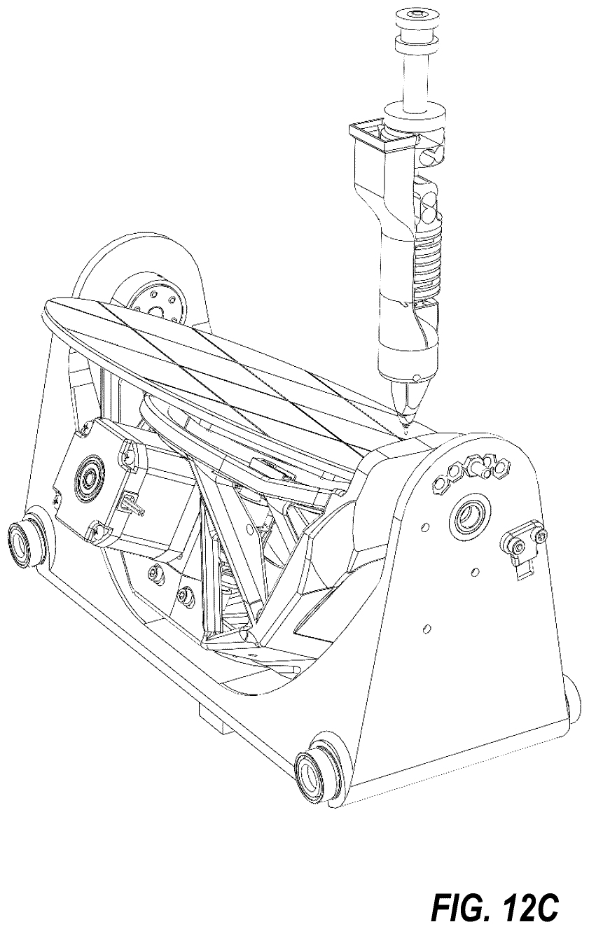

FIG. 12A is a perspective view of a print head 300 probing a location at the edge of a tilting print bed 110. FIG. 12B is a perspective view of the print head 300 of FIG. 12A probing a location near the midpoint of the tilting print bed 110, after tilting of the print bed 110 to a different position. FIG. 12C is a perspective view of the print head 300 of FIG. 12A probing a location at another edge of the tilting print bed 110, after tilting of the print bed 110 to a different position.

In some embodiments, this function can be additionally used to re-calibrate the position of the printer to resume an interrupted print job (e.g. after a power failure or if the print head has collided with another part of the printer or with the in-progress printed object). This method is more generally applicable to calibrating the position of the print head relative to a previously-printed object to conduct additional printing activities on or surrounding the same object.

In some embodiments, a printer may compensate for an expected deflection of the build platform as an in-progress model is constructed on the platform, resulting in a load which will change as the model is completed. Prior to executing a print job, the rigidity of the build platform can be measured by probing the surface at one or several locations using the print head while measuring the resulting force-deflection curve with force sensors located in the print head or beneath the build platform. The mass and center-of-mass location of a 3D printing job can in some embodiments be measured in advance as part of the toolpath generation process. As an alternative or in addition to such advance measurements, measurements may be taken during the print job using the toolpath commands or additional sensors on the printing apparatus. The measured mass is used to adjust subsequent toolpaths to compensate for any static and dynamic deflections of the printing apparatus, and this correction may be updated either continuously or periodically. This is particularly applicable to a printer with a tilting-rotating bed because the bed of such a printer can be less robustly supported than is feasible with a printer of comparable size but with a stationary bed. In addition, the tilting and rotation functions introduce additional sources of positioning error not present in conventional planar FDM machines.

The printing process itself can also incorporate a variety of additional steps or techniques, some of which may be unique to a five-axis 3D printer, while others may be performed using any suitable type of 3D printer. In some embodiments, pre-fabricated components can be integrated with a printed part during printing. In such an embodiment, a jig, fixture, or partial component can be printed on the build platform, and prefabricated components (e.g., bearings, fasteners) are placed in or on the printed structures on the build platform. The printing process can then then be resumed to secure and enclose the prefabricated components and create a “printed assembly.” In some embodiments, this can be done by the user manually placing the components. In other embodiments, the printer or a separate machine (for instance: a pick-and-place robot) can be used to place the components. The robot may then also remove the printed assembly and move it to a subsequent process (further assembly, shipping etc.), thereby fully automating the 3D printing process. In such an embodiment, human intervention can be reduced or entirely eliminated from the process.

In some embodiments, a non-layer-based technique can be used where unsupported rods of material are printed to construct a truss-like structure on the build platform. Material is extruded from the tool tip as the tool moves approximately along the axis of the rod segment to be formed, and cooling solidifies the rod in the absence of other support structures. In a particular embodiment, the cooling is provided by a stream or jet of air directed at or along the tool tip. In another embodiment, the cooling is achieved by a stream of air directed over the build platform or otherwise through the working volume of the printer. In some embodiments, the tool tip is paused temporarily when contacting or in close proximity to previously-printed material such that the previously-printed material is heated or partially re-melted to promote adhesion of additional material to be deposited. In some embodiments, the tool tip is paused temporarily at the conclusion of each individual rod member to provide temporary support and stabilization while the rod solidifies.

In another embodiment, an alternate process can be used for printing truss-like members. Such an embodiment may include a layer-based technique where the axis of each truss member is analyzed in the context of other adjacent members to determine a suitable tool orientation, and the truss member is then printed in layers which may or may not be normal to one or both of the tool tip and truss member axis. The truss cross-section may be of any shape, solid or hollow, and may vary between truss members and along the length of each truss member.

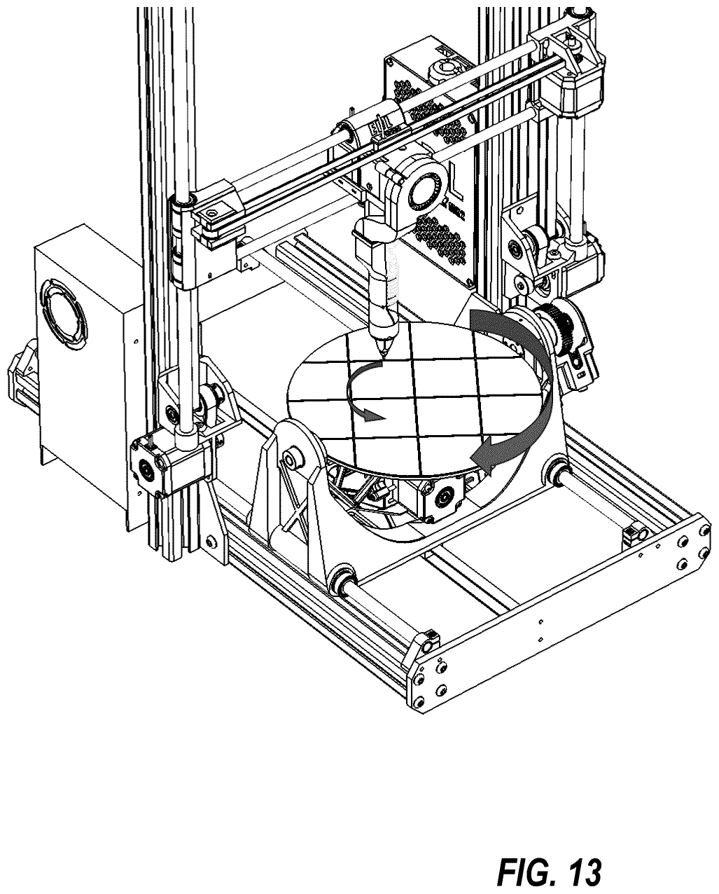

In some embodiments, rotation or other movement of the build platform can be used to increase printing speed. In some such embodiments, a method for increased printing speed can use the rotating axis of the build platform in conjunction with relative tool tip motion. Print material can be deposited by rotating the build platform while moving the tool tip in an opposing or partially opposing direction relative to the build plate frame of reference to increase the speed of relative motion thereby increasing the rate at which material can be added to the printed part. FIG. 13 is a perspective view of a printer with a rotating build platform, illustrating the build platform and print head being rotated in opposite directions to increase the relative rate of movement of the print head over the build platform.

In some embodiments, the printing process can include techniques for more closely matching the shape of the printed structure to the intended boundaries of the printed structure. For example, in order to avoid the staircase effect on angled surfaces, the printing toolpath can be modified such that the outermost lines of deposited material (or portions of those lines) have a lower thickness than the nominal thickness of the layer. By sequentially decreasing thickness towards the boundary of the printed layer to more closely interpolate the intended solid boundary, the staircase effect is reduced. An extension of this technique is to vary the local deposited thickness while simultaneously adjusting the relative orientation of the tool tip and the build platform such that the tool tip is approximately perpendicular to the local outwards normal vector of the desired printed geometry.

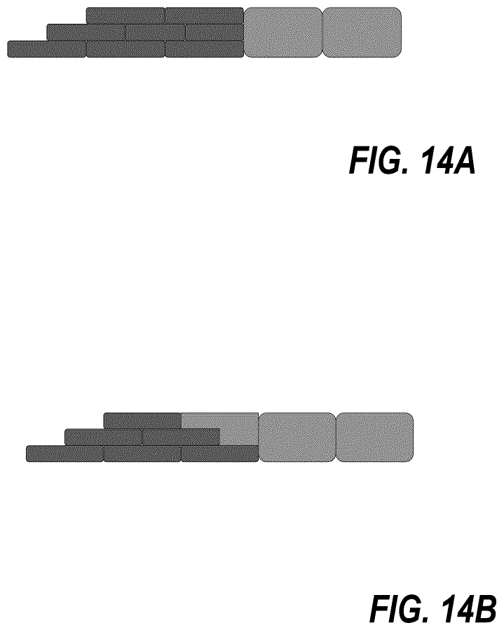

In similar embodiments, perimeter sections can be printed in a finely-stepped fashion, while inner infill sections can be printed in a more coarsely-stepped fashion. In such an embodiment, a part can be “sliced” into relatively coarse layers (i.e. to increase the achievable volumetric material deposition rate). A region around the boundary of each coarse layer is sliced into two or more layers of lesser thickness to increase surface detail. The thinner layers are printed first, and after they are complete the coarse internal region is printed. FIG. 14A illustrates an embodiment of such a method for printing a more finely-stepped thinner layer before printing a course internal region.

In some particular embodiments of this strategy, a roughly pyramidal arrangement of finer layers are printed to achieve the desired surface detail, and then coarse infill is applied in the remaining open cross-section of the layer using a variable-cross-section “space-filling” deposition path. FIG. 14B illustrates an embodiment of such a method for printing a more finely-stepped thinner layer before printing a course internal region, where the outer layers are printed in a pyramidal arrangement.

In some embodiments, various methods or techniques for model slicing and optimization can be performed. Some of these may be unique to a five-axis 3D printer, while others may be performed using any suitable type of 3D printer.

In some embodiments, methods and techniques may be used to segment a model for printing from multiple directions. In such an embodiment, a model can be segmented into regions to print using each of several orientations and/or layering paradigms (e.g., planar, cylindrical, spherical, conic). This segmentation can be accomplished by analyzing the local orientation of faces and features within the model to determine feasibility boundaries. Regions of effect are then defined based on the boundaries. For example, a central part of one shape might be printed in planar layers, and then subsequently some radially protruding features might be printed using cylindrical layers. In an alternative embodiment, the model may be segmented into regions defined by an assembly of geometric primitives (cylinders, prisms, hemispheres, etc.).

In some embodiments, methods and techniques may be used to reinforce segment interfaces in a segmented model. Boundaries between distinct regions of printing in a segmented model may create a local weakness if the boundary is flat and/or smooth. Embodiments of segment reinforcing methods can introduce interlocking shapes or textures to be printed at the interface(s) between segmented regions such that the interface is made mode resistant to fracture. The inclusion of such interfacial interlocking regions can be analogous to the use of biscuit, dowel, or dovetail joints in carpentry, embodiments of such techniques may extend such concepts to include shapes that cannot be assembled or disassembled conventionally. The textured interface is first printed on the initial region, and then the adjoining region is printed with a complementary shape.

In many embodiments, the interface region can be printed fully-dense for both the base component and the adjoining component, even if one or both components are otherwise printed at partial density. In some embodiments, the orientation of layers and/or print paths on the interface surface are tailored to increase the alignment of print paths to the direction of loads across the interface and thereby reduce the likelihood of fracture at or adjacent to the interface. In a particular embodiment, the shape of the interface is designed such that the components are mechanically interlocked from all directions and could not be disassembled even in the absence of adhesion between the two components.

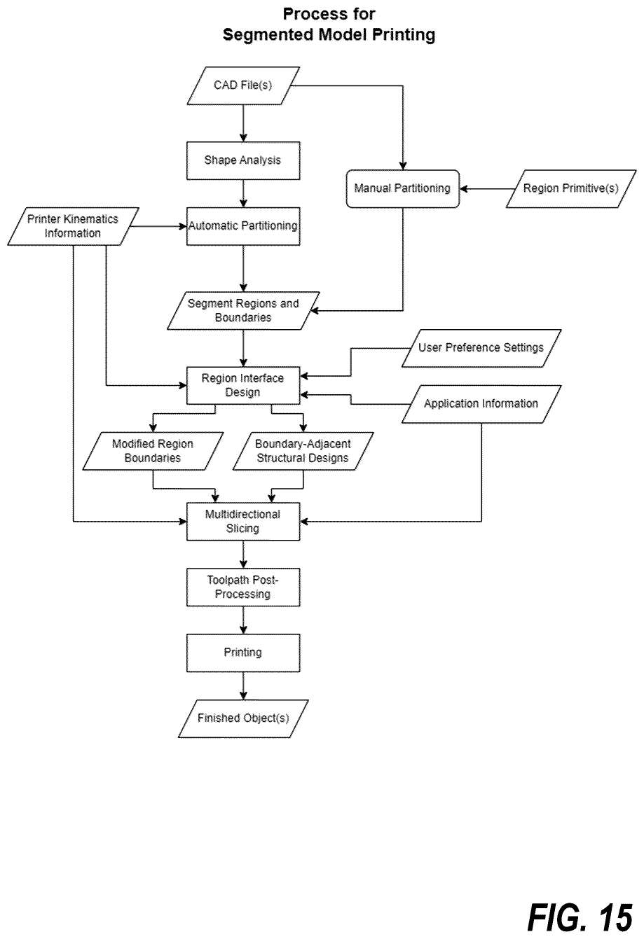

FIG. 15 is a process flow diagram illustrating various techniques and parameters that can be used in a method of segmental model printing. The illustrated flow chart is representative of various embodiments of modeling and printing processes consistent with this disclosure, some of which will omit certain techniques, processes, decisions, inputs or other manual actions, and other steps illustrated therein. Depending on the embodiment, for example, either one or both of manual or automatic partitioning may occur. In other embodiments, user preference settings can be taken into account, while in other embodiments no such settings may be considered.

In some embodiments, methods and techniques can be used for generating time-efficient infill patterns for a printer with a tilting-rotating bed. In such embodiments, infill patterns for nonplanar layers can be defined by actuating either or both of the tilting and rotating axes at a high rate, while moving the other axes as needed to maintain the tool tip at the desired distance and orientation relative to the local build surface (which may be the build platform or previously printed material).

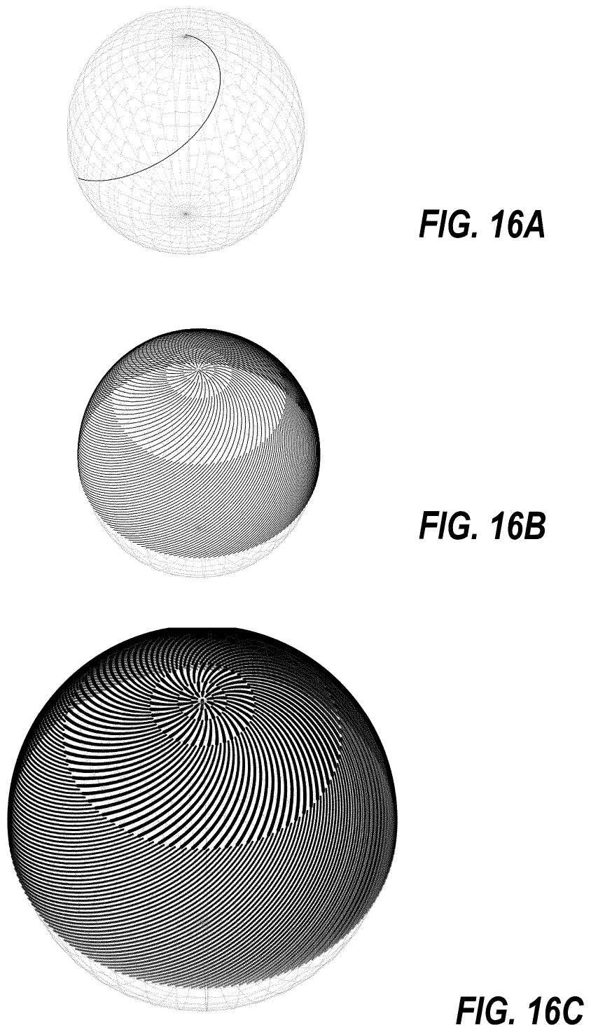

The path of each discrete line of infill can be determined according to the speed(s) of the axes used for the motion. In a particular embodiment, both a tilting and a rotating axis are actuated simultaneously to produce a print path on the in-progress layer surface having a generalized curve or spiral form (as shown in FIG. 16A for a spherical layer). Adjacent print paths are trimmed or offset as necessary to eliminate the occurrence of overlapping paths within a single printed layer (as shown in FIG. 16B). The width of material to be deposited in each path is varied according to the proximity of adjacent print paths such that the layer may be fully dense if so desired (as shown in FIG. 16C). The width and spacing of print paths may be modified to achieve a sparse (i.e. partial density) infill while using the described form of print path. In some embodiments, the direction of one or more motion components (e.g. the direction of rotation of an axis) may be reversed for some layers to apply print paths having a substantially different direction to those of an earlier layer. In a particular embodiment, such a change in direction is effected on every second layer of material deposited.

In some embodiments, methods and techniques can be used for generating slices where the deposition direction of the material varies from layer to layer. The direction material deposition on a 3D printer determines the direction in which the part will be strong. This is because there is a small difference in strength (even with isotropic materials) between successive material paths and also between successive material layers. Such embodiments can include intentionally varying the direction of deposition of the material deposition from layer to successive layer using a bias angle (0, 45, 90, −45, −90 etc.) similarly to how plywood is made, or how carbon-fiber based parts are built. This allows the part to be strong in all directions maximizing the strength of the plastic. This can apply both to isotropic printing materials as well as anisotropic printing materials. The method can be used for planar 3D printing as well as non-planar 3D printing processes.

In some embodiments, methods and techniques can be used for efficiently computing print paths and other data for non-planar printing. In contrast to well-developed methods for processing geometric shapes and print paths for two-dimensional geometries (i.e. as encountered in each layer of a planar FDM process), more generalized three-dimensional geometries are not well-developed. In certain embodiments, model geometry and/or print path data computed for a non-planar printing process in three dimensions can be transformed to a planar representation in two dimensions, various analyses and operations can be performed upon and using said data, and then the resulting outputs can then be transformed back to three dimensions. This improves the speed and convenience of certain toolpath calculations by enabling the use of existing algorithms and computer code for processing two-dimensional print path data to perform analogous operations on non-planar print path data. In a basic embodiment of such a method, a non-planar layer is transformed into planar coordinates by considering only two dimensions of a three-dimensional coordinate system while neglecting the third dimension, although such a simplification may not be preferable. In other embodiments, the specific transformation(s) applied relate to the non-planar geometry of the print layer under consideration in order to preserve the uniqueness of all locations within the domain of application and minimize unfavorable distortions (e.g. compression or excessive stretching) of the spatial data, representing an improvement over the basic embodiment discussed above. In one specific embodiment applicable to hemispherical layers, the transformed coordinates are computed as the azimuth angle and the great circle distance from the zenith of the corresponding hemisphere. In an embodiment applicable to cylindrical layers, the transformed coordinates are the azimuth angle and the vertical (altitude) coordinate. In some embodiments, a subsequent transformation is conducted between two-dimensional coordinate systems (e.g. from radial coordinates to Cartesian) for additional computational convenience, and the inverse of such transformations are additionally applied to reconstruct the three-dimensional data after two-dimensional calculation steps are performed.

In some embodiments, methods and techniques can be used for infill generation for angled or non-planar layers. In such techniques, material and or weight savings can be applied to the object to be printed that allows a reduced amount of material to be deposited. Some embodiments of printers can accomplish this in a planar (horizontal) fashion. However, embodiments described herein can extend such techniques to angled planes as well as non-planar geometry which require novel types of infill geometries and software algorithms to generate the geometries. Embodiments of such a process include first determining regions of a solid model to which infill strategies should be applied, and then generating print paths according to a specified pattern and density. The infill pattern may be generated either procedurally based on the location and thickness of a given non-planar layer, or else by computing the intersection between a given layer and a predefined space-filling infill pattern. Regardless, the infill is printed alongside the non-infilled areas during the deposition of each non-planar layer.

In some embodiments, methods and techniques can be used for optimization of material deposition paths for angled or non-planar layers, including optimization for isotropic and anisotropic materials. FDM printed material is stronger and/or stiffer along the direction in which it is deposited and so the strength and/or stiffness of a printed object can be improved by aligning printed paths to the local direction of maximum stress. This technique comprises optimization for weight, strength, stiffness or another physical property, and may be applied to a print where the material is either A) isotropic, B) anisotropic or C) a combination of both isotropic and anisotropic materials. The application of such methods to nonplanar shells and angled layers that are infeasible on conventional printers represents an important distinction over the use of such methods in planar layers. A representative but non-limiting embodiment can include receiving input from the user for the locations of loads and supports, analyzing the resulting stress intensities and directions within the model, determining a layering scheme that locally orients filament deposition lines to the directions of maximum stress, and provides the user with feedback on the extent of improvements made. Optionally, the user may specify certain conditions or limitations for the printed object or regions thereof to additionally constrain the optimization.

In other embodiments, the optimization can be conducted without explicit user input and is instead based on an inferred or user-selected category of load type (e.g. gravity loads, handling loads, impact loads) that is then automatically generated and applied to the model. In other embodiments, the optimization process receives loading information from an external FEA or CAD program that has previously computed loads, either for the printed component individually or for the component in the context of a larger assembly.

In some embodiments, methods and techniques can be used for optimization of infill patterns for nonplanar printing. In certain such embodiments, stresses and deflections of a designed object can be analyzed using FEA to inform and optimize the type, density, and orientation of infill for bulk regions within the object. In specific implementations, the method can consider the anisotropic nature of the printed material and vary the local layer orientation as part of the optimization process. A multi-scale optimization can be conducted considering at a large scale the regional density of the infill material as well as its type (for example, various truss or cellular architectures) and orientation, and then locally at a smaller scale considering the orientation of print deposition paths within the infill volumes. The latter may be wholly or partially conducted independently and/or in advance of the main optimization loop. In certain embodiments, such optimization necessarily considers feasibility constraints relating to tool tip access and clearance during the printed process. In some embodiments, the optimization is conducted without explicit user input and targets improved uniformity of in-plane strength. In other embodiments, user input is received regarding the type, location, and magnitude of loads experienced by the object, and the goal of the optimization is to best resist those loads.

While certain embodiments have been described, these embodiments have been presented by way of example only and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope of the disclosure.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Certain terminology may be used in the following description for the purpose of reference only, and thus is not intended to be limiting. For example, terms such as “upper”, “lower”, “upward”, “downward”, “above”, “below”, “top”, “bottom”, “left”, and similar terms refer to directions in the drawings to which reference is made. Such terminology may include the words specifically mentioned above, derivatives thereof, and words of similar import. Similarly, the terms “first”, “second”, and other such numerical terms referring to structures neither imply a sequence or order unless clearly indicated by the context.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “spherical” or “circular” or “cylindrical” or “semi-circular” or “semi-cylindrical” or any related or similar terms, are not required to conform strictly to the mathematical definitions of spheres, circles, cylinders or other structures, but can encompass structures that are reasonably close approximations.

The terms “approximately,” “about,” and “substantially” as used herein represent an amount close to the stated amount that still performs a desired function or achieves a desired result. For example, in some embodiments, as the context may permit, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may permit, the term “generally parallel” can refer to something that departs from exactly parallel by less than or equal to 20 degrees. As another example, in certain embodiments, as the context may permit, the term “generally perpendicular” can refer to something that departs from exactly perpendicular by less than or equal to 20 degrees.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

Although the invention has been disclosed in the context of certain embodiments and examples, it will be understood by those skilled in the art that this disclosure extends beyond the specifically disclosed embodiments to other alternative embodiments and/or uses of the embodiments and certain modifications and equivalents thereof. The scope of the present disclosure is not intended to be limited by the specific disclosures of preferred embodiments in this section or elsewhere in this specification, and may be defined by claims as presented in this section or elsewhere in this specification or as presented in the future.

1. A five-axis 3-D printer, comprising:
a tilting-rotatable bed comprising:
a build platform;
a rotating drive mechanism operably connected to the build platform to command a rotational position of the build platform; and
a tilting drive mechanism operably connected to the build platform to command a tilt position of the build platform; and
a print head positioned above the build platform, at least one of the build platform and print head being movable to command a position of the print head relative to the build platform along three orthogonal axes, at least one of the build platform and print head comprising a load cell.

2. The printer of claim 1, wherein the build platform is supported by an underlying support bracket tiltable by the tilting drive mechanism, and wherein the rotating drive mechanism is supported by the underlying support bracket.

3. The printer of claim 1, wherein the rotating drive mechanism is capable of infinitely rotating the build platform.

4. The printer of claim 1, wherein the build platform is supplied with electrical power via an electrical slip ring.

5. The printer of claim 1, wherein the build platform is operably connected to at least one of the rotating drive mechanism or the tilting drive mechanism via a worm gear.

6. The printer of claim 1, wherein the printer is configured to perform a calibration process to detect a rotational position of the build platform by detecting contact between the print head and the build platform at a plurality of rotational positions of the build platform.

7. The printer of claim 1, wherein the printer is configured to perform a calibration process to detect a tilt position of the build platform by detecting contact between the print head and the build platform at a plurality of tilt positions of the build platform.

8. The printer of claim 1, wherein the printer is configured to perform a compensation process to compensate for an expected deflection of the build platform as a model is constructed on the platform, the compensation process comprising:
probing the build platform at one or more locations while measuring a force-deflection curve, and
adjusting a toolpath of a printing process based on the measured force-deflection curve to compensate for deflection of the build platform due to the construction of a model on the build platform during the printing process.

9. The printer of claim 1, wherein the print head is spatially confined within a conical boundary volume originating at a distal tool tip of the print head, and wherein the conical boundary volume is defined by an included angle at the distal tool tip of at 20 degrees or less, and wherein the print head is further spatially confirmed within a cylindrical boundary volume coaxial with a longitudinal axis of the print head passing through the distal tool tip, and wherein the cylindrical boundary volume has a diameter of 20 mm or less.

10. (canceled)

11. (canceled)

12. The printer of claim 1, wherein the print head further comprises at least one light source to pre-heat a deposition area.

13. The printer of claim 1, wherein the print head is moveable to command a position of the print head relative to the build platform outside of a working volume overlying the tilting-rotatable bed and enclosed by vertical columns of the printer.

14. (canceled)

15. A printing process for constructing a model using a printer, the printer comprising:
a tilting-rotatable bed comprising:
a build platform;
a rotating drive mechanism operably connected to the build platform to command a rotational position of the build platform; and
a tilting drive mechanism operably connected to the build platform to command a tilt position of the build platform; and
a print head positioned above the build platform, at least one of the build platform and print head being movable to command a position of the print head relative to the build platform along three orthogonal axes, at least one of the build platform and print head comprising a load cell.

16. The printing process of claim 15, wherein the printing process comprises printing unsupported rods of material, wherein:
the unsupported rods of material are printed by moving the tool tip approximately along the axis of the rod segment to be formed, or
wherein the unsupported rods of material are printed in a layer which is not normal to at least one of a tool tip axis of the print head or an axis of the unsupported rods of material.

17. The printing process of claim 15, wherein the build platform is rotated in a first direction about a rotational axis of the build platform during a portion of the printing process, and wherein the print head is moved in a second direction about the rotational axis of the build platform during the same portion of the printing process, the second direction opposite the first direction.

18. The printing process of claim 15, further comprising a segmenting process to segment a model into regions to print using different orientations and/or different layering paradigms, wherein the printing process includes printing interlocking shapes or textures at boundaries between regions printed using different orientations and/or different layering paradigms.

19. The printing process of claim 15, wherein the printing process comprises printing nonplanar infill patterns while actuating at least one of the rotating drive mechanism or the tilting drive mechanism.

20. The printing process of claim 19, wherein printing the nonplanar infill patterns comprises:
printing a first layer of material, and
altering a direction of a motion component of the tilting-rotatable bed before printing a second layer of material.

21. The printing process of claim 15, wherein calculating a toolpath for the printing process comprises:
transforming model geometry and/or print path data computed for a printing process in three dimensions to a planar representation in two dimensions;
analyzing the two-dimensional planar representation to obtain an output; and
transforming the output to three-dimensional information.

22. The printing process of claim 15, wherein the printing process comprises conducting an optimization process to analyze stresses and deflections within an object to optimize at least one of type, density, and orientation of infill within the object.

23. The printing process of claim 15, wherein the printing process comprises conducting an optimization process to locally orient filament deposition lines to directions of maximum stress.
